(19) United States
(12) Patent Application Publication
(10) Pub. No.: US 2023/0238512 A1
(43) Pub. Date: Jul. 27, 2023

(54) LINKER-FUNCTIONALIZED METAL-ORGANIC FRAMEWORK FOR POLYSULFIDE TETHERING IN LITHIUM-SULFUR BATTERIES

(71) Applicant: The Johns Hopkins University, Baltimore, MD (US)

(72) Inventors: David Burns, Baltimore, MD (US); Avery E. Baumann, Baltimore, MD (US); Van Sara Thoi, Baltimore, MD (US)

(73) Assignee: The Johns Hopkins University, Baltimore, MD (US)

(21) Appl. No.: 18/009,659

(22) PCT Filed: Jun. 10, 2021
(86) PCT No.: PCT/US2021/036746

§ 371 Date: Dec. 9, 2022

Related U.S. Application Data
(60) Provisional application No. 63/037,378, filed on Jun. 10, 2020.

(51) Int. Cl. H01M 4/36; H01M 4/38; H01M 4/60; H01M 4/58

(52) U.S. Cl. CPC H01M 4/364; H01M 4/38; H01M 4/60; H01M 4/382; H01M 4/5815; H01M 2004/028

(57) ABSTRACT

An electrode includes at least one of sulfur (S) or selenium (Se), and a functionalized metal organic framework (R-MOF), the functionalized metal organic framework (R-MOF) having a functional group (R) attached to an organic portion of a metal organic framework (MOF). The functionalized metal organic framework (R-MOF) is adapted to react with at least one of electrochemically accessible sulfur (S) or selenium (Se) to capture at least one of lithium polysulfide or sodium polysulfide via covalent attachment of sulfur (S) or selenium (Se), respectively, to the functional group (R) of the functionalized metal organic framework (R-MOF).

### CROSS REFERENCE TO RELATED APPLICATION

The present application claims priority benefit to U.S. Provisional Pat. Application No. 63/037,378 filed on Jun. 10, 2020, the entire content of which is incorporated herein by reference.

### STATEMENT REGARDING FEDERALLY SPONSORED RESEARCH OR DEVELOPMENT

This invention was made with government support under grant No. 1945114 awarded by the National Science Foundation (NSF). The government has certain rights in the invention.

### BACKGROUND

### 1. Field of the Invention

The field of the currently claimed embodiments of this invention relates to electrodes, batteries, and methods of making the electrodes.

### 2. Discussion of Related Art

The perpetual growth in demand for energy storage devices to power portable devices and electric vehicles necessitates a search for affordable high-capacity batteries beyond lithium ion batteries. Lithium sulfur (Li—S) batteries are receiving tremendous attention as researchers hunt for the next big leap in battery technology. The attraction to Li—S batteries is sourced from the high theoretical specific energy (2,680 W h kg⁻¹) and energy density (2,199 W h L⁻¹) that promise to significantly enhance the energy storage capabilities of Li ion batteries. However, the discharge mechanism for the reduction of S₈ (and conversely the oxidation of Li₂S during charging), in Li—S cells leads to the generation of lithium polysulfides (Li₂Sₓ, x ≤ 8) at the cathode surface. These Li₂Sₓ species are electrochemically reduced to shorter chain lengths before being deposited as insoluble Li₂S₂ and Li₂S species at the end of discharge. However, the diffusion of dissolved Li₂Sₓ away from the surface of the cathode is the source of many problems, including cyclic instability and electrode passivation. The shuttling of lithium polysulfides Li₂Sₓ to the anode during cycling is known as the Shuttle Effect.

### SUMMARY OF THE DISCLOSURE

An aspect of the present disclosure is to provide an electrode including at least one of sulfur (S) or selenium (Se); and a functionalized metal organic framework (R-MOF), the functionalized metal organic framework (R-MOF) having a functional group (R) attached to an organic portion of a metal organic framework (MOF). The functionalized metal organic framework (R-MOF) is adapted to react with at least one of electrochemically accessible sulfur (S) or selenium (Se) to capture at least one of lithium polysulfide or sodium polysulfide via covalent attachment of sulfur (S) or selenium (Se), respectively, to the functional group (R) of the functionalized metal organic framework (R-MOF).

Another aspect of the present disclosure is to provide an electric battery including an anode comprising lithium or sodium; and a cathode including at least one of sulfur (S) or selenium (Se); and a functionalized metal organic framework (R-MOF), the functionalized metal organic framework (R-MOF) having a functional group (R) attached to an organic portion of the metal organic framework (MOF). The functionalized metal organic framework (R-MOF) is adapted to react with at least one of electrochemically accessible sulfur (S) or selenium (Se) to capture at least one of lithium polysulfide or sodium polysulfide via covalent attachment of sulfur (S) or selenium (Se), respectively, to the functional group of the functionalized metal organic framework (MOF).

A further aspect of the present disclosure is to provide a chemical composition for making an electrode for an electric battery having a metal organic framework (MOF) having an organic linker and a metal cluster; and a functional group (R). The functional group is linked to the organic linker of the metal organic framework to form functionalized metal organic framework (R-MOF). The functionalized metal organic framework (R-MOF) is adapted to react with at least one of electrochemically accessible sulfur (S) or selenium (Se) to capture at least one of lithium polysulfide or sodium polysulfide via covalent attachment of sulfur (S) or selenium (Se), respectively, to the functional group of the functionalized metal organic framework (R-MOF).

Another aspect of the present disclosure is to provide a method of producing a chemical composition for making an electrode for an electric battery. The method includes (1) providing a metal organic framework (MOF) having an organic linker and a metal cluster, the metal cluster comprising zirconium (Zr); (2) linking a functional group (R) to the metal organic framework (MOF) to form a functionalized metal organic framework (R-MOF) by incorporating a thiophosphate (PS_{X}), a thiogermanate (GeSₓ), or a thioarsenate (AsSₓ) functional group to the organic linker via a hydroxyl (—OH) group, the hydroxyl (—OH) group being used so that PCl₅ reacts with the organic linker using the following chemical reaction:

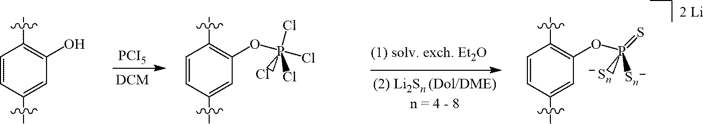

wherein P corresponds to phosphate and Cl corresponds to chlorine, and wherein wiggly lines in the chemical reaction correspond to chemical bonds to connect to the metal cluster.

### BRIEF DESCRIPTION OF THE DRAWINGS

The present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

FIG. 1 is schematic representation of the postulated structure of Mi—UiO—66 (depicted as the two polyhedra on the left) upon the introduction of lithium polysulfides (Li₂Sₓ, depicted as wiggly lines with spheres at the end), the control NH₂—UiO—66 (depicted as polyhedra on the right) and a schematic representation of the chemical tethering method in a MOF composite electrode (at the bottom of FIG. 1), according to an embodiment of the present invention;

FIGS. 2A and 2B show a capacity retention of Mi—UiO—66(blue) and NH₂—UiO—66(orange) cells cycled at C/10 for 1 cycle and C/2 for 100 cycles, according to an embodiment of the present invention;

FIG. 3A show XPS spectra of the S2p region of UiO—66@Li₂Sₓ, according to an embodiment of the present invention;

FIG. 3B shows XPS spectra of the S2p region of Mi—UiO—66@Li₂Sₓ, according to an embodiment of the present invention;

FIG. 4A shows UV-Vis absorption spectra solutions of Li₂Sₓ and Mi—BDOMe in DOL/DME, according to an embodiment of the present invention;

FIG. 4B shows the fluorescence emission spectra of Mi—BDOMe (left) and the Mi—BDOMe—Li₂Sₓ (right) solutions excited with 405 nm light, according to an embodiment of the present invention;

FIG. 5 shows ¹H NMR spectra of NPM (bottom) and NPM+Li₂Sₓ (top) collected in CD₃CN, according to an embodiment of the present invention;

FIG. 6 shows an illustration of lithium thiophosphate covalently tethered to the Zr node (left) and organic linker (right) within the MOF UiO—66, according to an embodiment of the present invention;

FIG. 7A shows solution state ¹H NMR spectra indicating the formation of BDC—OP species in comparison to BDC—OH, according to an embodiment of the present invention;

FIG. 7B shows peak assignments and highlight the extra peak splitting occurring from the proximity of the aromatic protons to the phosphorous nucleus, according to an embodiment of the present invention;

FIG. 7C shows solution state ³¹P NMR spectra of (a) the reaction mixture of Na₂BDC—OH and PCl₅, (b) digested UiO—66—OP50, and (c) PCl₅ all taken in 1 M NaOH in D₂O, according to an embodiment of the present invention;

FIG. 8A shows new features are observed for the UiO—66—OP25 and UiO—66—OP50 samples that were not present in the UiO-66-OH sample, according to an embodiment of the present invention;

FIG. 8B shows the P—O—C stretches are not observed in the spectra of materials obtained from the control reaction of UiO-66 and PCl₅, according to an embodiment of the present invention;

FIG. 9 shows galvanostatic Li—S cycling results for (a) UiO—66—Px (without added Li₂Sₙ) demonstrates the UiO—66—OP25 and UiO—66—OP50 cells deliver diminished capacity when compared to the control UiO—66—OH cells due polysulfide uptake, (b) for UiO—66—OPx and 10 mM Li₂S₄, (c) for UiO—66—OPx and 40 mM Li₂S₈, according to embodiments of the present invention;

FIG. 10A shows a cyclic voltammetry experiment conducted on symmetric cells composed of UiO—66—OH—Li₂S₈, according to an embodiment of the present invention. FIG. 10B shows a cyclic voltammetry experiment conducted on symmetric cells composed of UiO—66—OP25—Li₂S₈ electrodes, according to an embodiment of the present invention;

FIG. 11A shows a rate capability results from C/2 to 4C, according to an embodiment of the present invention;

FIG. 11B, shows the fifth cycle’s galvanostatic discharge curve at each C-rate for LPS—UiO—66(50Benz) (top) and UiO—66—OP25—Li₂S₈ (bottom), according to an embodiment of the present invention;

FIG. 12 shows the reaction of catechol and PCl₅ presented above yields various substituted phosphorane products distinguishable by NMR spectroscopy, with solution state ¹H NMR spectra taken in CD₃Cl₃ of (a) the first recrystallization from hexanes, (b) the crude reaction mixture, and (c) the catechol starting material, no catechol starting material is observed after reaction with PCl₅, solution state ³¹P NMR spectra taken in CDCl₃ of (d) the first recrystallization from hexanes, (e) the crude reaction mixture, and (f) the PCl₅ starting material, according to various embodiments of the present invention;

FIG. 13 shows the solution phase ³¹P NMR spectra of reaction products of phenol and PCl₅ taken in 1 M NaOH/D₂O solutions, according to an embodiment of the present invention;

FIG. 14 shows the Solution phase ¹H NMR spectra of reaction products of phenol and PCl₅ taken in 1 M NaOH/D₂O solutions, according to an embodiment of the present invention;

FIG. 15 shows solution phase NMR results obtained from degraded (a) UiO—66—OP50, (b) UiO—66—OP25, and (c) UiO—66—OH in 1 M NaOH in D₂O, according to embodiments of the present invention;

FIG. 16 shows solution state ¹H NMR spectra of digested (a) UiO—66 + PCl₅ reaction product and reference (b)UiO—66 spectrum, the peaks at 7.7 ppm and 8.3 ppm correspond to the BDC linker and formate respectively, the formate signal decreases relative to BDC after treatment of UiO—66 with PCl₅, no new features are observed to indicate reaction with the linker, solution state ³¹P NMR spectra of (c) digested UiO—66 + PCl₅ and reference (d) PCl₅ confirm no phosphorous species other than PO₄³⁻ (signal at 5.6 ppm) present in the digestion solution, according to embodiments of the present invention;

FIG. 17 shows a comparison of FT-IR spectra between the (a) molecular and (b) MOF systems with and without phosphorous incorporation, according to an embodiment of the present invention;

FIG. 18 shows X-ray diffraction patterns for UiO—66, UiO—66—OH, and the functionalized UiO—66—OP25 sample indicate the MOFs all exhibit the same crystalline structure, according to an embodiment of the present invention;

FIG. 19 shows solution phase ³¹P NMR spectra display the results from various PCl₅ + Li₂S₈ reactions, according to embodiment of the present invention;

FIG. 20 shows solution phase ³¹P NMR spectra display the reaction solutions from PCl₅ + Li₂S reactions at various stoichiometric S/P ratios, according to an embodiment of the present invention;

FIG. 21 shows UV-Vis spectra using (a) 50 µL and (b) 100 µL of the MOF + Li₂S₈ reaction solutions after extended soaking, according to embodiments of the present invention;

FIG. 22 shows a comparison of FT-IR spectra between the (a) molecular and (b) MOF systems before and after the phosphorous compounds are exposed to the polysulfide solution;

FIG. 23 shows FT-IR spectra of the (a) UiO-66-OH and (b) UiO-66 series of powders at different stages of functionalization, according to an embodiment of the preset invention;

FIG. 24 shows all galvanostatic cycling results compared to the performance of a control 45 % S/C cell that does not contain any MOF additive, according to an embodiment of the present invention;

FIG. 25 shows CV results for cells containing various MOF additives, according to an embodiment of the present invention;

FIG. 26 shows compiled EIS results for cells examined in this study, each plotted versus the average final capacities of the cells containing the different MOF additives, according to an embodiment of the present invention;

FIG. 27 shows the rate capabilities for various cells with panel (a) is the same as in FIG. 11A, according to an embodiment of the present invention;

FIG. 28 shows in plots (a-f) galvanostatic discharge curves at different C-rates, according to an embodiment of the present invention;

FIG. 29 shows schematically an electrode, according to an embodiment of the present invention; and

FIG. 30 shows schematically an electric battery, according to an embodiment of the present invention.

### DETAILED DESCRIPTION

Some embodiments of the current invention are discussed in detail below. In describing embodiments, specific terminology is employed for the sake of clarity. However, the invention is not intended to be limited to the specific terminology so selected. A person skilled in the relevant art will recognize that other equivalent components can be employed and other methods developed without departing from the broad concepts of the current invention. All references cited anywhere in this specification, including the Background and Detailed Description sections, are incorporated by reference as if each had been individually incorporated.

Lithium-sulfur (Li—S) batteries have great potential as next generation batteries. However, the inherent redox chemistry mechanism creates complications such as leaching of active material which leads to diminished capacities and passivated electrodes. Chemical tethering of lithium polysulfides to materials in the sulfur cathode make up a promising approach for resolving this issue in Li—S batteries. Borrowing from the field of synthetic chemistry, we utilize a maleimide-functionalized metal-organic framework (Mi-MOF) as a material capable of chemically interacting with polysulfides through the Michael Addition reaction. A combination of molecular and solid-state spectroscopy confirms covalent attachment of Li₂Sₓ to the maleimide functionality. When integrated into Li—S cathodes, the Mi-MOF exhibits notable performance enhancements over that of unfunctionalized MOF cathode additives.

In pursuit of designing Li—S cells worthy of competing with Li ion technologies, a number of materials have been explored to combat the Shuttle Effect at the sulfur cathode including metal-organic frameworks (MOFs). Metal organic frameworks (MOFs) are hybrid materials, built up from an organic part, a linker, and an inorganic part, the cornerstone. MOFs are porous, crystalline materials with finely controllable chemical and physical properties afforded through metal cluster and organic linker designs as well as post-synthetic functionalization. The high surface area of porous MOFs can be used to physically adsorb soluble Li₂Sₓ to mitigate their diffusion away from the cathode. Although this method often provides improvements in performance, physisorption does not sufficiently solve polysulfide dissolution over long term cycling. Chemisorption sites provide stronger association between Li₂Sₓ and the internal surface of the material and have been shown effective for enhancing the cycle life of Li-S batteries.

An aspect of the present invention is an electrode including at least one of sulfur (S) or selenium (Se); and a functionalized metal organic framework (R-MOF), the functionalized metal organic framework (R-MOF) having a functional group (R) attached to an organic portion of a metal organic framework (MOF). The functionalized metal organic framework (R-MOF) is adapted to react with at least one of electrochemically accessible sulfur (S) or selenium (Se) to capture at least one of lithium polysulfide or sodium polysulfide via covalent attachment of sulfur (S) or selenium (Se), respectively, to the functional group (R) of the functionalized metal organic framework (R-MOF).

In an embodiment, the functional group (R) includes a maleimide (Mi) functional group. In an embodiment, the functional group (R) includes a thiophosphate (PS_{X}), a thiogermanate (GeSₓ), or a thioarsenate (AsSₓ) functional group. In another embodiment, the functional group (R) includes a selenophosphate (PSeₓ), a selenogermanate (GeSeₓ), or a selenoarsenate (AsSeₓ) functional group.

In an embodiment, the functionalized metal organic framework (R-MOF) has pores and at least one of selenium (Se) or the sulfur (S) is deposited within the pores. In another embodiment, the functionalized metal organic framework (R-MOF) and at least one of selenium (Se) or the sulfur (S) can be mixed together.

In an embodiment, at least one of sulfur (S) or selenium (Se) is present in a proportion of 40 wt% to 90 wt% and the functionalized metal organic framework (R-MOF) is present in a proportion of 0.1 wt% to 30 wt%.

In an embodiment, the metal organic framework (MOF) includes zirconium, hafnium, cesium, copper, zinc, titanium, iron, vanadium, molybdenum, niobium, and/or chromium metal ions. In an embodiment, the metal organic framework (MOF) can be any one of UiO—66, MOF—808, and NU—1000.

In an embodiment, the functional group (R) of the functionalized metal organic framework (R-MOF) is adapted to covalently react with the lithium polysulfide or sodium polysulfide to capture the lithium polysulfide or the sodium polysulfide. In an embodiment, the lithium polysulfide may include for example Li₂Sₓ, where x = 1 to 8. In an embodiment, the sodium polysulfide may include for example Na₂Sₓ, where x = 1 to 8.

Another aspect of the present invention is to provide an electric battery. The electric battery includes an anode having lithium or sodium and a cathode. The cathode includes at least one of sulfur (S) or selenium (Se); and a functionalized metal organic framework (R-MOF), the functionalized metal organic framework (R-MOF) having a functional group (R) attached to an organic portion of the metal organic framework (MOF). The functionalized metal organic framework (R-MOF) is adapted to react with at least one of electrochemically accessible sulfur (S) or selenium (Se) to capture at least one of lithium polysulfide or sodium polysulfide via covalent attachment of sulfur (S) or selenium (Se), respectively, to the functional group of the functionalized metal organic framework (MOF).

In an embodiment, the functional group (R) may include a maleimide (Mi) functional group. In an embodiment, the functional group (R) can include a thiophosphate (PS_{X}), a thiogermanate (GeSₓ), a thioarsenate (AsSₓ) functional group, a selenophosphate (PSeₓ), a selenogermanate (GeSeₓ), or a selenoarsenate (AsSeₓ) functional group.

In an embodiment, the functionalized metal organic framework (R-MOF) includes pores and at least one of selenium (Se) or the sulfur (S) is deposited within the pores or the functionalized metal organic framework (R-MOF) and at least one of selenium (Se) or the sulfur (S) are mixed together.

In an embodiment, at least one of sulfur (S) or selenium (Se) is present in a proportion of 40 wt% to 90 wt% and the functionalized metal organic framework (MOF) is present in a proportion of 0.1 wt% to 30 wt%.

In an embodiment, the metal organic framework (MOF) includes zirconium, hafnium, cesium, copper, zinc, titanium, iron, vanadium, molybdenum, niobium, or chromium metal ions. In an embodiment, the metal organic framework (MOF) can be any one of UiO—66, MOF—808 and NU—1000.

In an embodiment, the functional group (R) of the functionalized metal organic framework (R-MOF) is adapted to covalently react with the lithium polysulfide or sodium polysulfide to capture the lithium polysulfide or the sodium polysulfide.

In an embodiment, the lithium polysulfide can include Li₂Sₓ, where x = 1 to 8. In an embodiment, the sodium polysulfide can include Na₂Sₓ, where x = 1 to 8.

A further aspect of the present invention is to provide a chemical composition for making an electrode for an electric battery. The chemical composition includes a metal organic framework (MOF) having an organic linker and a metal cluster; and a functional group (R). The functional group is linked to the organic linker of the metal organic framework to form functionalized metal organic framework (R-MOF). The functionalized metal organic framework (R-MOF) is adapted to react with at least one of electrochemically accessible sulfur (S) or selenium (Se) to capture at least one of lithium polysulfide or sodium polysulfide via covalent attachment of sulfur (S) or selenium (Se), respectively, to the functional group of the functionalized metal organic framework (R-MOF).

In an embodiment, the functional group (R) can include a maleimide (Mi) functional group. In an embodiment, the functional group (R) includes a thiophosphate (PS_{X}), a thiogermanate (GeSₓ), a thioarsenate (AsSₓ) functional group, a selenophosphate (PSeₓ), a selenogermanate (GeSeₓ), or a selenoarsenate (AsSeₓ) functional group.

In an embodiment, the functionalized metal organic framework (R-MOF) has pores and at least one of selenium (Se) or the sulfur (S) is deposited within the pores or the functionalized metal organic framework (R-MOF) and the at least one of selenium (Se) or the sulfur (S) are mixed together.

In an embodiment, at least one of sulfur (S) or selenium (Se) is present in a proportion of 40 wt% to 90 wt% and the functionalized metal organic framework (R-MOF) is present in a proportion of 0.1 wt% to 30 wt%. In an embodiment, the metal organic framework (MOF) comprises zirconium, hafnium, cesium, copper, zinc, titanium, iron, vanadium, molybdenum, niobium, or chromium metal ions.

In an embodiment, the functionalized metal organic framework (R-MOF) can be any one of UiO-66, MOF-808 and NU-1000. In an embodiment, the functional group (R) of the functionalized metal organic framework (R-MOF) is adapted to covalently react with the lithium polysulfide or sodium polysulfide to capture the lithium polysulfide or the sodium polysulfide.

Yet another aspect of the present invention is to provide a method of producing a chemical composition for making an electrode for an electric battery. The method includes providing a metal organic framework (MOF) having an organic linker and a metal cluster, the metal cluster comprising zirconium (Zr); and linking a functional group (R) to the metal organic framework (MOF) to form a functionalized metal organic framework (R-MOF) by incorporating a thiophosphate (PS_{X}), a thiogermanate (GeSₓ), or a thioarsenate (AsSₓ) functional group to the organic linker via a hydroxyl (—OH) group, the hydroxyl (—OH) group being used so that PCl₅ reacts with the organic linker using the following chemical reaction:

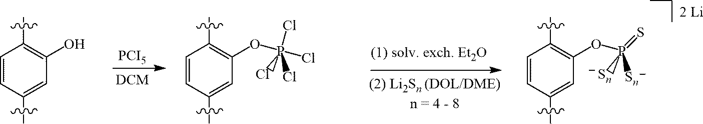

wherein P corresponds to phosphate and Cl corresponds to chlorine, and
wherein wiggly lines in the chemical reaction correspond to chemical bonds to connect to the metal cluster.

In an embodiment, the functionalized metal organic framework (R-MOF) is adapted to react with at least one of electrochemically accessible sulfur (S) or selenium (Se) to capture at least one of lithium polysulfide or sodium polysulfide via covalent attachment of sulfur (S) or selenium (Se), respectively, to the functional group (R) of the functionalized metal organic framework (R-MOF).

The following paragraphs provide further details of the various embodiments of the invention including specific implementation, examples and testing. An improved approach is presented wherein “defect sites” in Zr-based MOF strategy are functionalized to incorporate covalent sites for anchoring polysulfides through the use of lithium thiophosphate (Li₃PS₄) moieties. The covalent anchoring sites is effective for improving sulfur utilization and retention of Li₂Sₓ.

Taking advantage of the synthetic versatility of MOFs, we explored novel methods to enhance the number of covalent anchor sites. One strategy to accomplish this goal is incorporate the anchor site on the organic linker. In this work, we use maleimide-functionalized UiO-66 (Mi—UiO—66) for the capture of polysulfides. UiO—66 and various modified version of this material have attracted great interest. Inspired by its previous use in fluorescent chemical sensing of thiols, maleimide was chosen as an ideal anchor site for its selective reactivity towards thiols through the Michael Addition mechanism. This reactivity has led to its widespread use in organic and biochemistries as well as polymer and materials chemistries. Notably, the base-catalyzed Michael addition involves the deprotonation of thiols to create the more reactive thiolate anion for faster reactions. We anticipated that the maleimide functionality will analogously react with the di-anionic polysulfides generated during Li—S cycling. Herein, we report the ability of Mi—UiO—66to chemically tethering Li₂Sₓ through covalent linkage, thereby enhancing the performance of Li—S batteries.

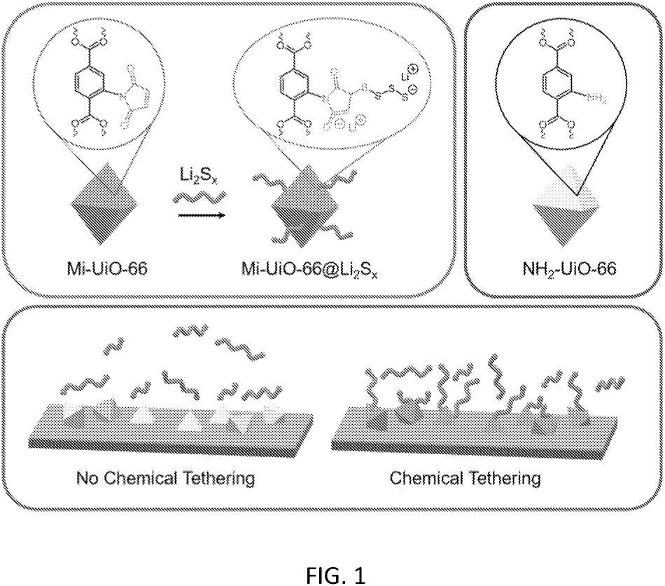

FIG. 1 is schematic representation of the postulated structure of Mi—UiO—66 (depicted as the two polyhedra on the left) upon the introduction of lithium polysulfides (Li₂Sₓ, depicted as wiggly lines with spheres at the end), the control NH₂—UiO—66(depicted as polyhedra on the right) and a schematic representation of the chemical tethering method in a MOF composite electrode (at the bottom of FIG. 1), according to an embodiment of the present invention.

The material UiO-66 is synthesized in the Catalysis group at the Department of Chemistry, University of Oslo. UiO-66 is a metal organic framework build up from terephthalic acid and a zirconium-containing cornerstone. Mi—UiO—66is synthesized according to literature procedure and powder X-ray diffraction and IR spectroscopy confirm the successful synthesis. Incorporation of Mi is demonstrated by digesting Mi—MOF in D₂SO₄/D₂O. ¹H NMR spectroscopy verifies virtually 100% incorporation of the Mi functional group into the MOF linkers retained the Mi group through the synthesis.

Upon confirming successful synthesis of Mi—MOF, we utilized the framework material as a cathode additive for Li—S batteries. The MOF composite cathodes containing Mi—UiO—66and the parent MOF NH₂—UiO—66 are assembled into 2032 coin cells using a Li metal anode and a Celgard separator in the presence of 1.0 M lithium bis(trifluoromethanesulfonyl)imide (LiTFSI) and 2 wt% LiNO₃ in 1:1 dioxalane and dimethoxyethane (DOL/DME). The coin cells were first cycled galvanostatically at a charge and discharge rate of C/2 after one cycle of C/10.

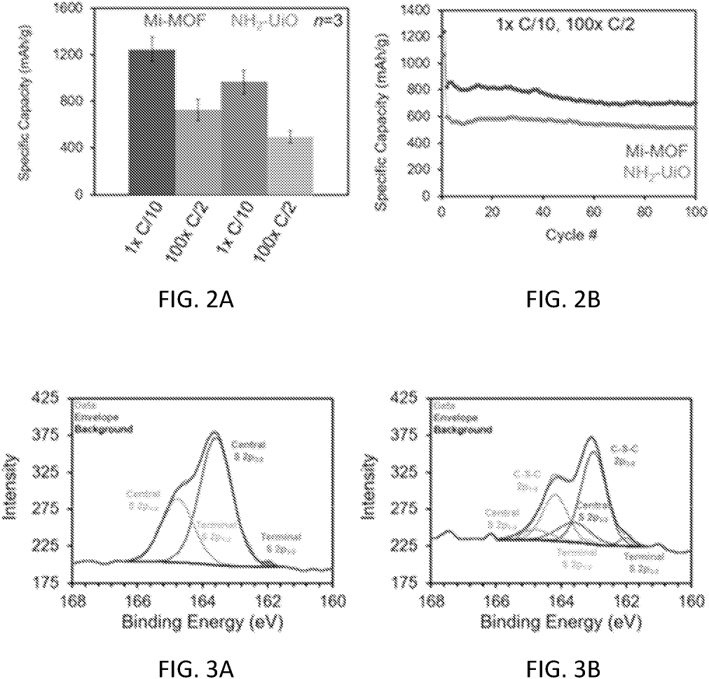

FIGS. 2A and 2B show a capacity retention of Mi—UiO—66(blue) and NH₂—UiO—66(orange) cells cycled at C/10 for 1 cycle and C/2 for 100 cycles, according to an embodiment of the present invention. FIG. 2A is bar graph of an average initial (solid) and final (striped) capacities of each type of cell, according to an embodiment of the present invention. FIG. 2B show a plot of the capacity delivered for representative cells over 100 cycles, according to an embodiment of the present invention. As shown in FIGS. 2A and 2B the initial discharge capacity at C/10 of Mi—UiO—66is 1247 ± 107 mA h g⁻¹ is compared to 968 ± 99 mA h g⁻¹ for NH₂—UiO—66. Although both Mi—UiO—66and NH₂—UiO—66 both have similarly stable capacity fade, capacity retention of Mi—UiO—66 cells after 99 cycles at C/2 is notably greater than that of the NH₂—UiO—66 cells (FIG. 2B). This observation suggests greater sulfur utilization was achieved with the addition of the Mi functional group, likely through its ability to covalently tether sulfur species during extended cycling. The galvanostatic cycling curves demonstrate that both the charge and discharge voltages are most favorable in the Mi—UiO—66 cells. The reduction of polarization compared to NH₂—UiO—66 suggests that Mi—UiO—66 improves the reaction kinetics for sulfur conversion.

These trends are also maintained across varied charge and discharge rates. At all C-rates, the Mi—UiO—66 cells exhibit higher specific capacities compared to NH₂—UiO—66. Moreover, galvanostatic charge and discharge curves show that the NH₂—UiO—66 cells exhibit much stronger polarization and struggle to produce stable plateaus. The remarkable performance of Mi—UiO—66 as a cathode additive motivates a fundamental analysis on what is happening on a molecular level. We thus turned to spectroscopic studies to evaluate the reaction mechanism behind the improved capacity retention and sulfur utilization.

We first explore the reaction between Mi—UiO—66 and Li₂Sₓ through X-Ray Photoelectron Spectroscopy (XPS). To prepare the samples, UiO-66 and Mi—UiO—66 are immersed in solutions of Li₂S₈ overnight and filtered to obtain solid powders. FIG. 3A show XPS spectra of the S2p region of UiO-66@Li₂Sₓ, according to an embodiment of the present invention. FIG. 3B shows XPS spectra of the S2p region of Mi—UiO—66@Li₂Sₓ, according to an embodiment of the present invention. As shown in FIGS. 3A and 3B, the presence of Li₂Sₓ was observed in survey scans of both MOFs, suggesting that the porosity of the frameworks provides high surface area for the physical adsorption of Li₂Sₓ. Prominent S2p_{3/2} and S2p_{½} peaks for mid-chain S atoms of Li₂Sₓ were seen in both samples at 163.5 eV and 164.8 eV at the expected separation of 1.2 eV and 2:1 intensity ratio. Less conspicuous peaks assigned to the S2p_{3/2} and S2p_{½} of the terminal S atoms in Li₂Sₓ are observed at 162.0 eV and 163.2 eV in both samples as well. Upon further inspection of the S2p region, clear chemical differences between UiO—66@Li₂Sₓ and Mi—UiO—66@Li₂Sₓ are observed. A prominent S2p_{3/2} and S2p_{½} peaks assigned to an S atom in the C—S moiety at 163.0 eV and 164.2 eV is detected in the Mi—UiO—66@Li₂Sₓ sample that is noticeably absent in UiO@Li₂Sₓ. These features align well with other literature containing maleimide Michael addition adducts. These results strongly suggest that lithium polysulfides generated during cycling can react with the Mi functionality in the framework.

In order to provide further clarity on the reaction mechanism, we studied model reactions between maleimide-functionalized organic molecules and Li₂Sₓ. The methyl ester analog of Mi—BDC (Mi—BDOMe) was a convenient first choice. Upon addition of the white Mi—BDOMe solid to the orange, saturated Li₂Sₓ (x ≥ 8) solution, an immediate color change to deep red was observed, which is consistent with the formation of the maleimide enolate.

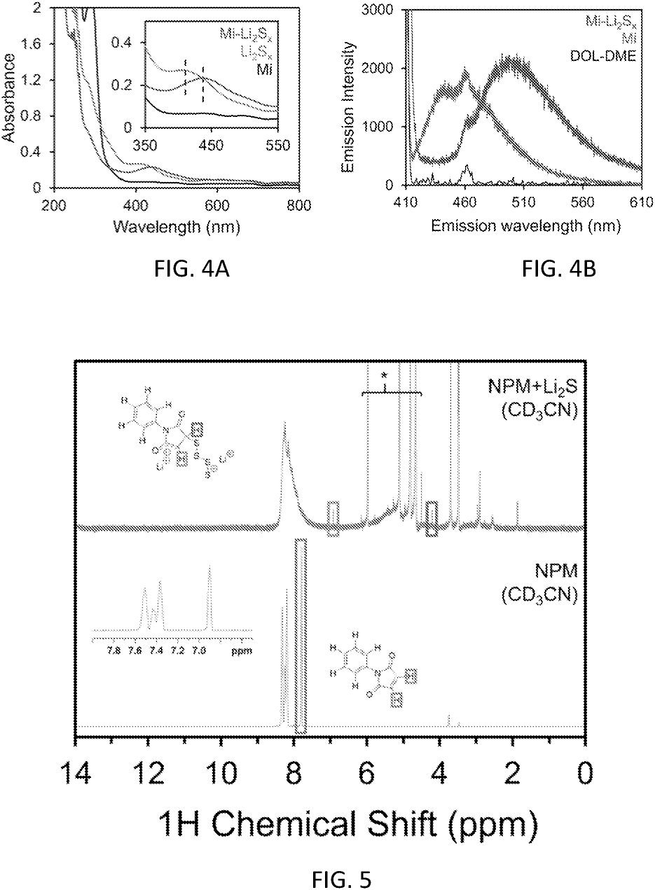

FIG. 4A shows UV-Vis absorption spectra solutions of Li₂Sₓ and Mi—BDOMe in DOL/DME, according to an embodiment of the present invention. The inset shows the color change upon addition of Mi—BDOMe to Li₂Sₓ. FIG. 4B shows the fluorescence emission spectra of Mi—BDOMe (left) and the Mi—BDOMe—Li₂Sₓ (right) solutions excited with 405 nm light, according to an embodiment of the present invention. UV-Vis absorption spectra showed a redshift of 30 nm in the absorption of the solution. Increasing the concentration of the Mi—BDOMe leads to a corresponding increase in the absorption of the new feature. Fluorescence spectroscopy further confirms the chemical connectivity between Mi—BDOMe and Li₂Sₓ (FIG. 4B). Evidence of the adduct is shown by the shift of the peak emission wavelength, λₘₐₓ, to ~490 nm, which agrees with the λₘₐₓ of the Mi—UiO—66 following Michael addition of thiols. Thus, we anticipate the Mi-BDC linker is capable of chemically tethering Li₂Sₓ in the DOL/DME solvent environment.

FIG. 5 shows ¹H NMR spectra of NPM (bottom) and NPM+Li₂Sₓ (top) collected in CD₃CN, according to an embodiment of the present invention. NPM alkene protons are highlighted (gray square boxes), and the enolate product peaks are highlighted (rectangular boxes). The asterisk (*) indicates peaks from residual DOL/DME. In search of structural confirmation of the reaction products to provide insight into maleimide and Li₂Sₓ chemistry, N-phenyl maleimide (NPM) is used as a proxy for the Mi linker in ¹H and ¹³C NMR experiments. Upon exposing a solution of NPM to Li₂S, significant changes are observed in the ¹H NMR spectrum (FIG. 5), in addition to a change to a deep red color. Importantly, the peak associated with the alkene protons in the NPM spectrum disappears in the NPM+Li₂S spectrum, which is consistent with the anticipated loss of the alkene after the Michael addition. Meanwhile, two other features of equal integration appear at 5.89 ppm and 2.77 ppm. Formerly in the alkene, these protons are assigned to the enolate (O—C═CH—C) and CH—S, respectively. It is worth noting that the broaden features from 6-8 ppm and 3-5 ppm, as well as the additional features under 3 ppm, have previously been assigned to the homopolymerization of maleimide groups. The polymerization is propagated by the enolate product which further supports the formation of the enolate following the addition of Li₂Sₓ to the maleimide moiety.

Likewise, ¹³C NMR spectra show the peaks associated with the carbonyls at 169.6 ppm and the maleimide alkene at 134.0 ppm shift to new positions upon addition of Li₂Sₓ to the solution of NPM. The carbonyls, now inequivalent, are observed at 158.3 ppm and 157.3 ppm. The ¹³C shift from the alkene has notably decrease in intensity and a new peak at 52.3 ppm are assigned to the carbon in the C—S bond. Other features, including near 175 ppm and below 50 ppm arise from the maleimide homopolymer byproduct as observed in the ¹H NMR spectrum. The polymerization side reactions are specific to these soluble molecular models and will not take place in the Mi—UiO—66 due to the fixed positions of the MOF linkers. Corroborating the NMR results, the Michael addition is also confirmed in Fourier Transform Infrared Absorption Spectroscopy by the reduction of the strong C—H alkene peak at 829 cm⁻¹, as well as the shifting of the imide peak from 1144 cm⁻¹ to 1179 cm⁻¹ following the reaction.

The maleimide functionalized group is selected as a strong candidate for chemical anchoring of Li₂Sₓ to improve Li—S battery performance. When added to Li—S cathodes, the Mi-MOF provided enhanced capacity, cyclic stability, and reduced polarization. Furthermore, our combined electrochemical and spectroscopic studies reveal the reactivity of the maleimide-functionalized linker towards Li₂Sₓ via the Michael Addition pathway. XPS provided clear evidence that the Mi functional groups in Mi—UiO—66 is capable of covalently tethering Li₂Sₓ via a C—S bond, while a series of molecular studies validated the reactivity of the Mi functional group and structure of the resulting products. Future efforts are focused on understanding how chemical tethering affects sulfur speciation and their concentration in solution.

In a recent study involving various Li—S liquid electrolyte types and concentrations, it is concluded that electrolyte formulations that allow for greater solubility of Li₂Sₓ help to delay the deposition of insoluble Li₂S₂/Li₂S, thereby extending the lower discharge plateau to access greater capacity. The caveat is greater solubility of Li₂Sₓ leads to higher losses in capacity with each cycle due to leaching, revealing the trade-off between cycle stability and high capacity. In an embodiment, the chemical tethering technique can uniquely enable both high capacity and capacity retention. By covalently anchoring a portion of the soluble Li₂Sₓ population to a solid material such as Mi-MOF, Li₂Sₓ is removed from the bulk solution while remaining electrochemically accessible. The lower concentration of Li₂Sₓ in solution promotes further conversion of solid S₈ to soluble Li₂Sₓ, which ultimately creates a larger population of electrochemically accessible sulfur during cell cycling and delays deposition of Li₂S₂ and Li₂S. This process thus simultaneously increases sulfur utilization and inhibits the Shuttle Effect. In summary, we demonstrate a novel chemical strategy for covalently tethering polysulfides in MOFs during Li—S cycling. More broadly, our findings offer new design strategies for functionalizing other materials beyond MOFs, such as carbons and polymers, with potential benefits for advancing energy storage devices.

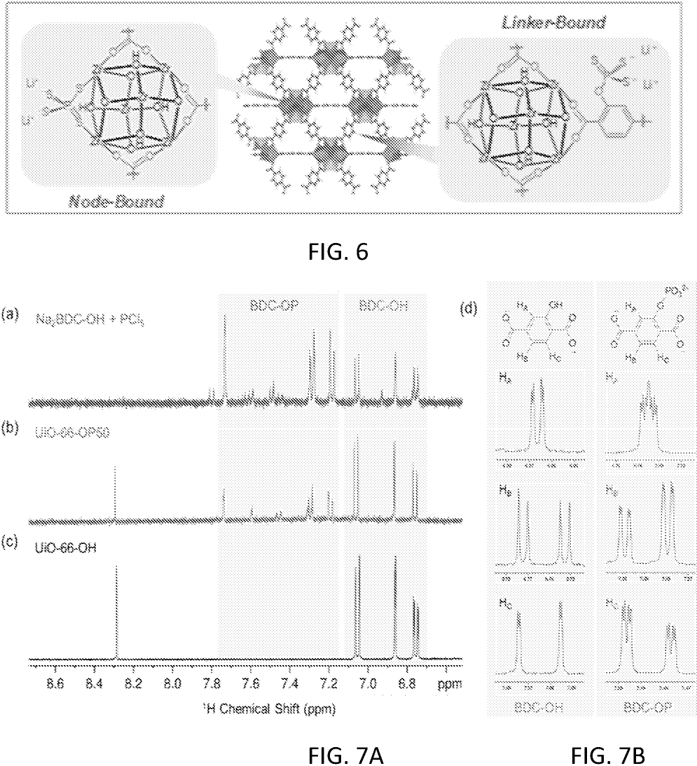

We demonstrate that incorporation of lithium thiophosphate (Li₃PS₄ or LPS) into Zr MOFs is possible via a chemical reaction with the coordinatively unsaturated metal node. The extent of LPS incorporation is controllable by adjusting both the quantity of open binding sites on the Zr node and the stoichiometric equivalents of Li₃PS₄ used in the synthesis. Ultimately, we found the thiophosphate functionalized MOFs improved sulfur utilization and capacity retention when implemented in Li-S battery cathodes, where samples with more phosphorous performed best within the same MOF series (either MOF—808 or UiO—66). To expand on this observation, the phosphorous content in the MOF is increased by instead using the organic linker component to anchor the thiophosphate moiety, as shown in FIG. 6. FIG. 6 shows an illustration of lithium thiophosphate covalently tethered to the Zr node (left) and organic linker (right) within the MOF UiO—66, according to an embodiment of the present invention.

In UiO—66, the chemical structure of the MOF contains six ditopic benzene dicarboxylate (BDC) linkers per formula unit (Zr₆(µ₃-OH)₄(µ₃-O)₄(BDC)₆). Even in the most defected UiO—66 samples, the maximum number of open sites capable of binding LPS is roughly three per formula unit. Therefore, utilization of the linker sites represents an alternative strategy to dramatically increase the concentration of LPS in the functionalized MOF. Additionally, the organic linker provides a convenient investigative handle to probe the reactivity of the thiophosphate in Li—S cycling conditions via complementary spectroscopic techniques.

In the following paragraphs, we provide a synthetic route to incorporate five-membered phosphoranes (PX₅) with labile P—Cl bonds into the MOF structure that can then be converted to the thiophosphate group. The MOF itself is a derivative of UiO-66 containing aromatic —OH functional groups on the organic linker (2-hydroxyterphthalate (BDC—OH)) and is appropriately named UiO—66—OH. The phosphorane is installed via this phenolic anchor using PCl₅, which forms a P—O linkage and releases HCl. The strength of the P—O bond secures the phosphorous atom to the linker, while the remaining P—Cl bonds are exchangeable with sulfide ligands to create a covalently tethered thiophosphate molecule. We offer spectroscopic evidence to confirm these synthetic manipulations and include demonstrations of analogous chemistry in a molecular (non-MOF) system for additional support.

Finally, we conduct a series of electrochemical analyses to assess the contribution of the linker-bound thiophosphate species and compare results with our previous LPS-node studies. Both this system and the previous approach are inherently complex. The information taken together from these studies can help identify translatable aspects, strengths, and weaknesses of these strategies and influence the next iteration of thiophosphate-functionalized materials. We envision this additional mechanistic insight and adaptability of the synthetic method to both MOF and non-MOF materials can serve as a strong foundation to support the growth of phosphorous chemistry in Li—S batteries and beyond.

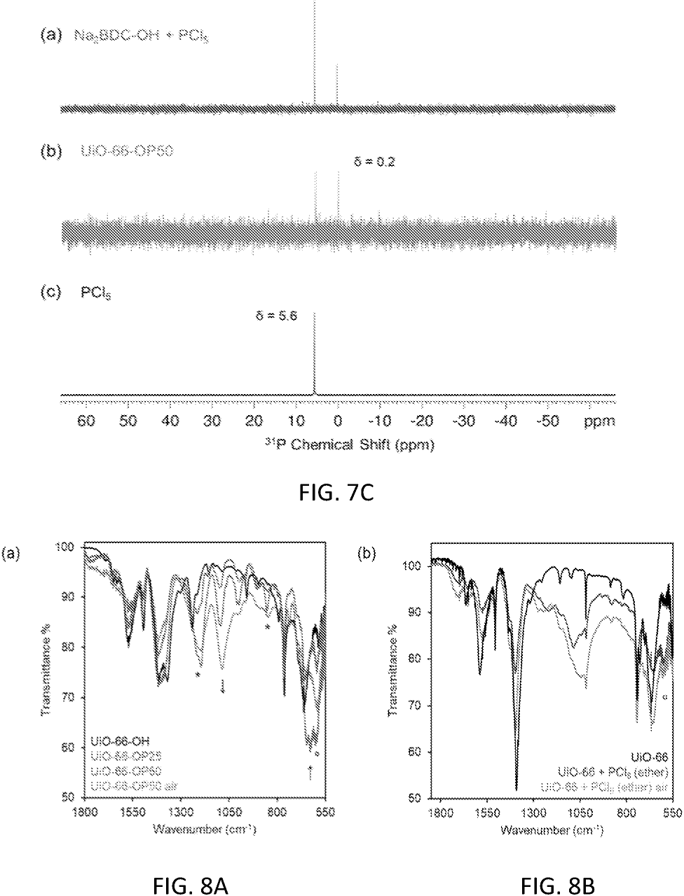

Phosphorane (PX₅) Reactivity and Incorporation into MOF. Molecular Studies: PCl₅ is a well-known chlorinating reagent in synthetic organic chemistry, reacting with alcohols to form alkyl chlorides via substitutive chlorination. Chlorination of aromatic alcohols (ArOH) has not been observed using PCl₅ or PCl₃, typically instead forming substituted chlorophosphoranes (ArO)ₓPCl₅₋ₓ. We demonstrate this through a preliminary control reaction, where catechol (cat) and PCl₅ are reacted to form various substituted phosphoranes with 1-3 cat ligands replacing the chlorine atoms (FIGS. 7A, 7B).

The following chemical reaction shows a reaction of catechol (cat) and PCl₅ which can accept substituted phosphoranes. Only one product (catPCl₃) is shown, but other degrees of substitution are also possible.

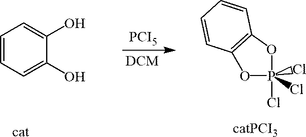

The catechol substituted species (catPCl₃, cat₂PCl, and cat₃P) are simpler to separate and identified by their distinct ³¹P NMR signals appearing at -21, - 9, and + 10 ppm (FIG. 12) and described previously. Further workup can provide the pure catPCl₃ compound that we are currently pursuing to complete this study. FIG. 12 shows the reaction of catechol and PCl₅ presented above yields various substituted phosphorane products distinguishable by NMR spectroscopy, with solution state ¹H NMR spectra taken in CD₃Cl₃ of (a) the first recrystallization from hexanes, (b) the crude reaction mixture, and (c) the catechol starting material, no catechol starting material is observed after reaction with PCl₅, solution state ³¹P NMR spectra taken in CDCl₃ of (d) the first recrystallization from hexanes, (e) the crude reaction mixture, and (f) the PCl₅ starting material, according to various embodiments of the present invention. More highly substituted species (cat₂PCl and cat₃P) are observed in both the crude and recrystallized samples.

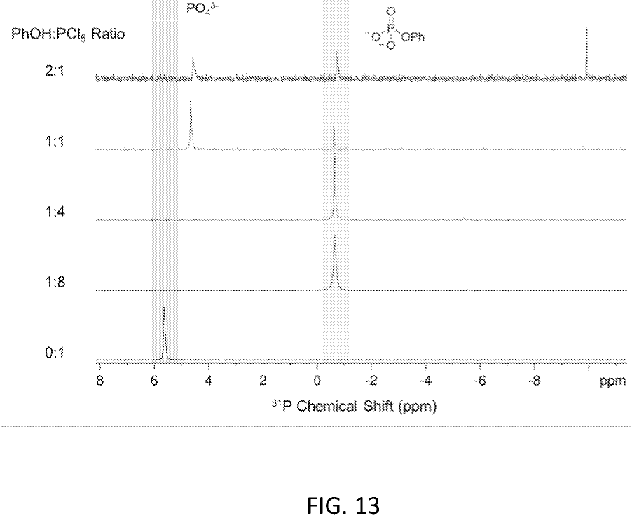

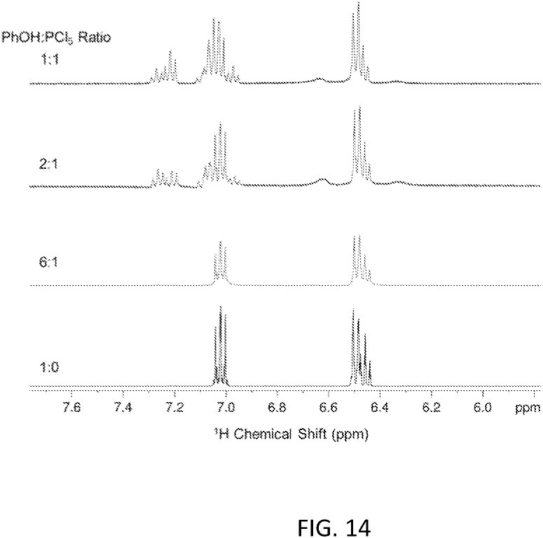

FIG. 13 shows the solution phase ³¹P NMR spectra of reaction products of phenol and PCl₅ taken in 1 M NaOH/D₂O solutions, according to an embodiment of the present invention. The molar ratio of phenol (PhOH) to PCl₅ corresponding to each spectrum is provided to the left of the figure. The highlighted peaks at 5.6 ppm and 0.7 ppm are attributed to PO₄³⁻ and the monosubstituted phenylphosphate complex. FIG. 14 shows the Solution phase ¹H NMR spectra of reaction products of phenol and PCl₅ taken in 1 M NaOH/D₂O solutions, according to an embodiment of the present invention. The molar ratio of phenol (PhOH) to PCl₅ corresponding to each spectrum is provided to the left of the figure. The appearance of new features in the top two spectra indicate coordination complexes are formed from the reaction.

We also explored reactivity of PCl₅ with phenol to that similarly yielded substituted phosphorus compounds as demonstrated by shifts in ³¹P and ¹H NMR spectroscopies (FIGS. 13 and 14). However, we found separation of substituted phosphoranes exceedingly challenging due to the wider distribution of products. We will use both the catechoxy- and phenoxy-substituted phosphoranes as models to understand MOF functionalization as the molecular compounds are far simpler to characterize and assign features than the extended MOF structure.

Installation in MOFs:

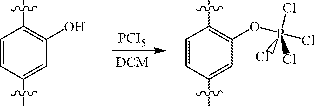

Hypothesized phosphorane coordination within the UiO-66-OH structure via the BDC-OH linker.

We first set out to identify MOFs with the following key characteristics: (i) chemical robustness to withstand functionalization and Li—S cycling conditions, (ii) capability to support linkers containing an aromatic —OH group, and (iii) capable of gram-scale synthesis of highly crystalline material for battery production. Suitable candidates were found in UiO—66 derivatives containing —OH functional group on the traditional BDC linker (BDC—OH) resulting in UiO—66—OH. Other candidates were also identified but are not explored in this study. We targeted post-synthetic functionalization strategies, rather than synthesizing the MOF with a thiophosphate linker, because of the known binding capabilities of the metal node with phosphorous species.

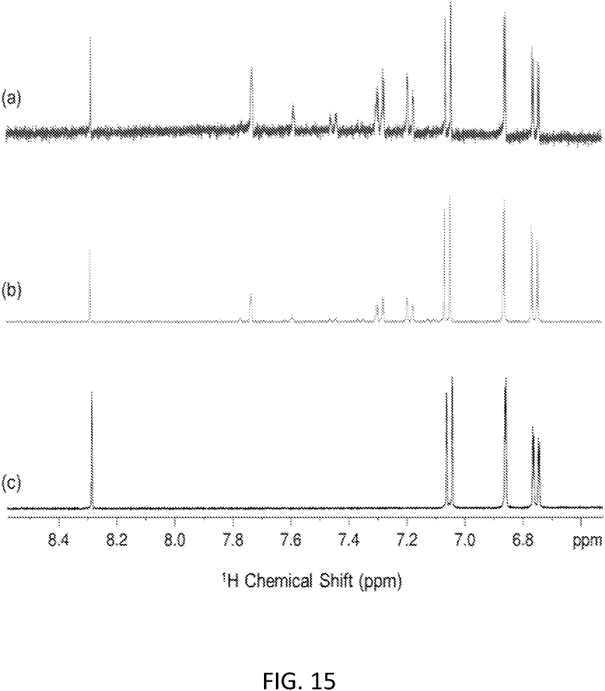

We utilize the similar chemistry to install phosphorous onto the MOF linker, 2-hydroxyterepthlate (BDC—OH), inUiO—66—OH. UiO—66—OH and PCl₅ are reacted to form UiO—66—OPx, where x is the % of linker functionalized as determined by ¹H NMR spectroscopy. Here, two varieties are studied, where x = 25 % or x = 50 %, obtained by modulating the stoichiometric amount of PCl₅ used in the functionalization procedure (FIG. 15, Table 1).

FIG. 15 shows solution phase NMR results obtained from degraded (a) UiO—66—OP50, (b) UiO—66—OP25, and (c) UiO—66—OH in 1 M NaOH in D₂O, according to embodiments of the present invention. Table 1 provides molar ratios of BDC-OP or formate to the total linker amount (BDC—OH + BDC—OP) found for digested MOF samples.

TABLE 1

| Sample | BDC-OP | Formate |
|---|---|---|
| UiO—66—OH | 0 | 0.38 |
| UiO—66—OP25 | 0.25 | 0.12 |
| UiO—66—OP50 | 0.48 | 0.21 |

We confirm this reaction using a handful of spectroscopic tools including NMR and infrared spectroscopies. Solution-state ¹H NMR spectra were collected on MOFs digested using 1 M NaOH/D₂O before and after reaction with PCl₅. The digested UiO—66—OH sample yields the three expected doublets for each of the aromatic protons of BDC—OH at shifts between 6.7 - 7.1 ppm along with a singlet for formate at 8.3 ppm (FIGS. 7A and 7B).

FIG. 7A shows solution state ¹H NMR spectra indicating the formation of BDC-OP species in comparison to BDC—OH, according to an embodiment of the present invention. The bottom two spectra were obtained from digesting (c) UiO—66—OH and (b) UiO—66—OP50 samples, respectively, according to embodiments of the present invention. The reaction mixture of Na₂BDC—OH and PCl₅ is presented in (a) and features similar BDC—OH and BDC—OP species as discussed in the text. All spectra were taken in 1 M NaOH in D₂O. FIG. 7B shows peak assignments and highlight the extra peak splitting occurring from the proximity of the aromatic protons to the phosphorous nucleus, according to an embodiment of the present invention.

After reaction with PCl₅, the ¹H NMR spectrum of the digested UiO—66—OP50 sample exhibits a prominent new trio of doublets with downfield chemical shifts between 7.2 - 7.8 ppm that we attribute to the phosphorous-bound BDC—OP. Some minor peaks are also observed in this region that display the characteristic trio of doublets, indicating possible trace quantities of BDC—OP derivatives (FIG. 15).

A control reaction using the sodium salt of the linker BDC—OH was also undertaken to gain insight to the identity of this new species. ¹H NMR spectra of the reaction also obtained in 1 M NaOH solution in D₂O reveals BDC—OP peaks of identical chemical shift and splitting, although the reaction was incomplete as seen with continued observation of BDC-OH. Since all NMR spectra are taken in aqueous conditions, we do not expect any acyl chloride generated from a side reaction with PCl₅ in solution as acyl chlorides would be instantaneously converted back to the carboxylate ion. A more detailed examination of the fine splitting of the BDC-OP shifts in the ¹H NMR spectrum reveals all peaks undergo another degree of coupling, indicating the phosphorous nucleus is in close proximity to the aromatic protons.

FIG. 7C shows solution state ³¹P NMR spectra of (a) the reaction mixture of Na₂BDC—OH and PCl₅, (b) digested UiO—66—OP50, and (c) PCl₅ all taken in 1 M NaOH in D₂O, according to an embodiment of the present invention. The peak at 5.6 ppm corresponds to PO₄³⁻ product resulting from hydrolyzed PCl₅ and is observed in all spectra. The signal at 0.2 ppm is attributed to hydrolyzed BDC—OP and is in the appropriate position for a monosubstituted phosphoester (ROPO₃²⁻) species. The ³¹P NMR spectra in FIG. 7C provides similar confirmation where peaks are observed for hydrolyzed PCl₅ as PO₄³⁻ at 5.6 ppm and the hydrolyzed BDC-OP compound at 0.2 ppm, a shift in agreement with a monosubstituted phosphoester compound (ROPO₃²⁻). Regardless of the washing extent, some uncoordinated PO₄³⁻ is present in the digested MOF NMR spectra, hinting there may also be coordination of PCl₅ to the Zr node in addition to the linker bound species.

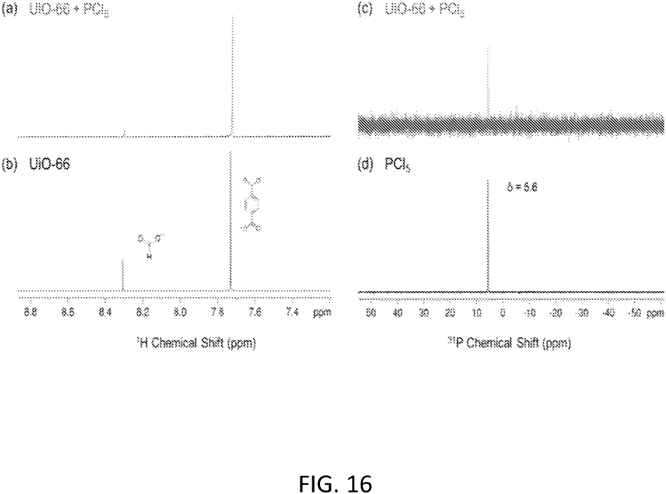

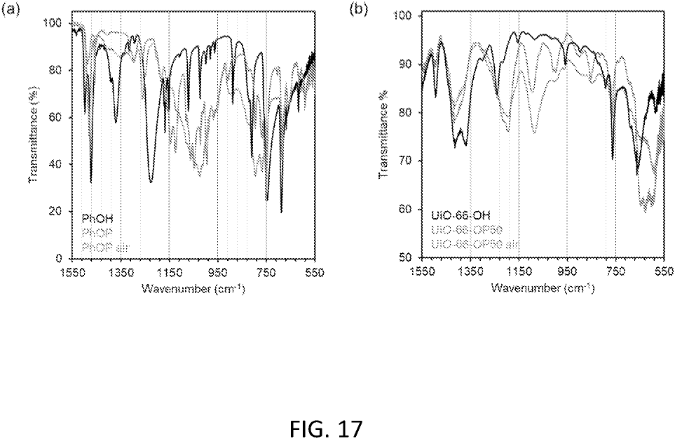

To assess possible coordination of PCl₅, we also subjected UiO—66 to our phosphorous loading procedure. In UiO—66, the linker is an unfunctionalized terephthalate (BDC) and should not yield any incorporated organophosphorus compounds. As expected, the digested UiO—66 sample treated with PCl₅ shows no new features in the ¹H NMR spectrum (FIG. 16). FIG. 16 shows solution state ¹H NMR spectra of digested (a) UiO—66 + PCl₅ reaction product and reference (b) UiO—66 spectrum, the peaks at 7.7 ppm and 8.3 ppm correspond to the BDC linker and formate respectively, the formate signal decreases relative to BDC after treatment of UiO—66 with PCl₅, no new features are observed to indicate reaction with the linker, solution state ³¹P NMR spectra of (c) digested UiO—66 + PCl₅ and reference (d) PCl₅ confirm no phosphorous species other than PO₄³⁻ (signal at 5.6 ppm) present in the digestion solution, according to embodiments of the present invention. A decrease in formate intensity and the existence of the PO₄³⁻ signal after addition of PCl₅ suggests replacement of nodal ligands with an inorganic phosphorous moiety. However, we note the relative integration of the BDC to formate shifts is decreased. Examination of the ³¹P NMR spectrum of the same digested sample shows only the peak at 5.6 ppm attributed to inorganic phosphate (PO₄³⁻) (FIG. 16). These results indicate phosphorous may bind to the node structure, likely replacing the formate ligand on the hexanuclear Zr cluster.

FIG. 8A shows new features are observed for the UiO—66—OP25 and UiO—66—OP50 samples that were not present in the UiO—66—OH sample, according to an embodiment of the present invention. The signals we assign to the symmetric and asymmetric P—O—C stretches (marked with *) persist upon air exposure. A simultaneous increase in the P—O stretch near 1100 cm⁻¹ and a decrease in the P—Cl stretches near 700 cm⁻¹ upon air exposure are suggestive of P—Cl bond hydrolysis. FIG. 8B shows the P-O-C stretches are not observed in the spectra of materials obtained from the control reaction of UiO—66 and PCl₅, according to an embodiment of the present invention. The features around 560 cm⁻¹ (marked with o) is attributed to vibrations of the Zr node and are considerably shifted from the parent MOF features in both (a) and (b), suggesting PCl₅ reacts with the metal node cluster.

Vibrational spectroscopy is another valuable tool to elucidate the binding mechanism of PCl₅ within these MOFs owing to the characteristic stretches of various phosphorous compounds. The signals for P—O vibrations are typically very strong in Fourier-transform infrared spectroscopy (FT-IR), where differing moieties bound to the oxygen result in distinct peak positions. In FIG. 8A, the parent UiO—66—OH powder is compared to UiO—66—OP50. Two peaks corresponding to the symmetric and asymmetric P-O-C stretches are observed at 1190 cm⁻¹ and 854 cm⁻¹ and are denoted with an asterisk. These features do not appear to be air-sensitive, consistent with our NMR studies. The very strong P—OH signal is also apparent at 1100 cm⁻¹ and grows in with continued air exposure from P—Cl bond hydrolysis. Features below 750 cm⁻¹ correspond to P—Cl and nodal vibrations. The concomitant decrease in intensity of the sharp peak at 627 cm⁻¹ with increase in the aforementioned P—OH stretch (at 1100 cm⁻¹) indicates this feature is likely P-Cl related.

Additional FT-IR spectra obtained from the control rection of UiO—66 + PCl₅ are provided in FIG. 8B. As expected, we don’t see P-O-C features indicative of organophosphorus compounds in agreement with our NMR analysis. However, we do observe a new feature at low wavenumber (marked with a circle) after reaction, suggesting chemical alteration of the Zr node structure. To further support our peak assignments, we return to our model compound studies where the broad Ar-OH features diminish and new P-O-Ar signals appear after reaction with PCl₅ (FIG. 17). FIG. 17 shows a comparison of FT-IR spectra between the (a) molecular and (b) MOF systems with and without phosphorous incorporation, according to an embodiment of the present invention. Peaks of interest are listed in Table 2 below. The agreements in assignments and positions suggest the reactivity in these two systems is similar. Peak assignments for PCl₅ functionalized MOF and molecular species are compiled and compared to the MOF in Table 2. Table 2 provides the peak positions and assignments of interest from spectra in FIG. 17. All values are given in cm⁻¹.

TABLE 2

| | PhOH | PhOP | UiO-66-OH | UiO-66-OP50 |
|---|---|---|---|---|
| O—H (in plane bend) | 1369 | - | 1368, 1:1 with 1414 (COO) | Diminished, not 1:1 with 1414 |
| O—H (out of plane bend) | 1224 | - | 1238 | Shoulders with 1190 peak |
| Ar—O—P symm | - | 1144, 1124 | - | 1190 |
| Ar—O—P asymm | - | 912, 904 | - | 854 |
| P—OH | - | 1050 - 950 (broadens w/ air exposure) | - | 1120 - 1000 (broadens w/ air exposure) |
| P—Cl | - | 591 | - | 627 |

We observe excellent correlation between their P-O-C features and similar changes as the samples are exposed to air.

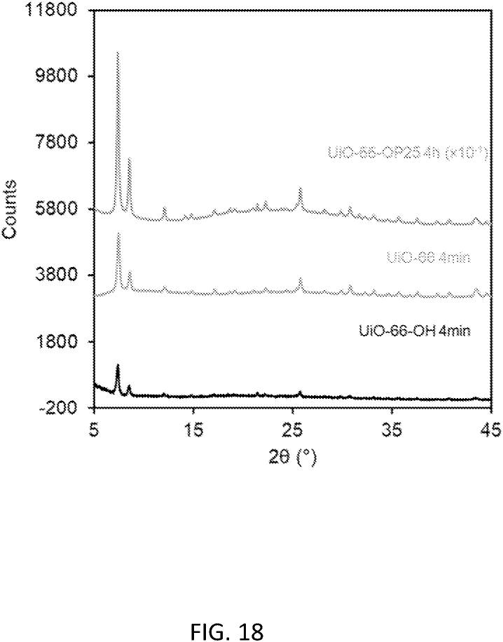

The ratio of P to Zr by weight percent in UiO—66—OP50 was found to be 0.15 by elemental analysis (Table 3). This incorporation of P is far higher than the values obtained in our previous node functionalization approach that was only 0.01 in defected UiO-66. Furthermore, we demonstrate the loading of P can be controlled through variation of the amount of PCl₅ employed - although stochiometric equivalency above 4 results in material degradation via our current synthesis methods. However, at lower stoichiometries, the characteristic X-ray diffraction pattern remains unchanged from the parent UiO—66—OH material (FIG. 18). FIG. 18 shows X-ray diffraction patterns for UiO—66, UiO—66—OH, and the functionalized UiO—66—OP25 sample indicate the MOFs all exhibit the same crystalline structure, according to an embodiment of the present invention. Data availability at the time of writing limited us to these samples with mixed collection parameters (either 4 min or 4 h scan time, denoted in figure), but the characteristic features are identifiable in all patterns. The two functionalized samples we will continue discussing (UiO—66—OP25 and UiO—66—OP50) were selected to compare the influence phosphorous incorporation on both polysulfide capture and Li—S battery performance. Table 3, part (a) provides quantification of Zr and P obtained by ICP-OES. Results from our previous research are provided in part (b) for comparison. Formate amount was not included in the calculation of the molecular weight or molecular formula presented below for simplicity. Calc. formula for UiO—66—OP50 = Zr₆(OH)₄(O₄)(BDC—OH)₃(BDC—OPCl₄)₃. Calc. molecular weight = 1810 g mol⁻¹

TABLE 3

(a)

| | Calc. Mass % P | Found Mass % P | Calc. Mass % Zr | Found Mass % Zr |
|---|---|---|---|---|
| UiO-66-OP50 | 5.1 | 4.6 | 30.2 | 30.1 |

(b)

| | | |
|---|---|---|
| | Calc. P/Zr Mass Ratio | Found P/Zr Mass Ratio |
| UiO-66-OP50 | 0.169 | 0.153 |
| LPS-UiO-66(50Benz) | - | 0.008 |
| 1xLPS-MOF-808 | - | 0.031 |

Sulfide Substitution to Yield the Thiophosphate: In the next step, we convert the labile P—Cl bonds to P—S using solutions of lithium polysulfides (Li₂Sₙ, where n = 4 or 8) as shown in diagram which is Schematic representation of the proposed P—Cl to P—S conversion reaction using lithium polysulfides (Li₂Sₙ, where n = 4-8) and our thiophosphate binding hypothesis.

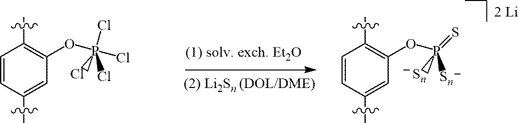

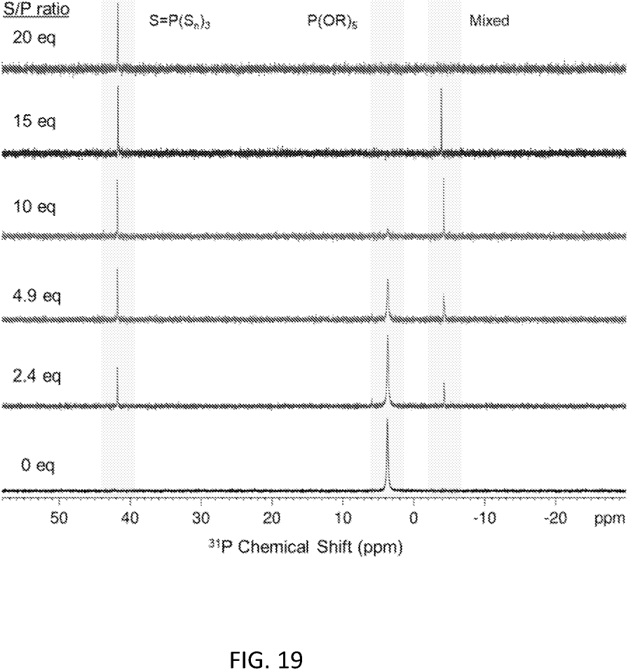

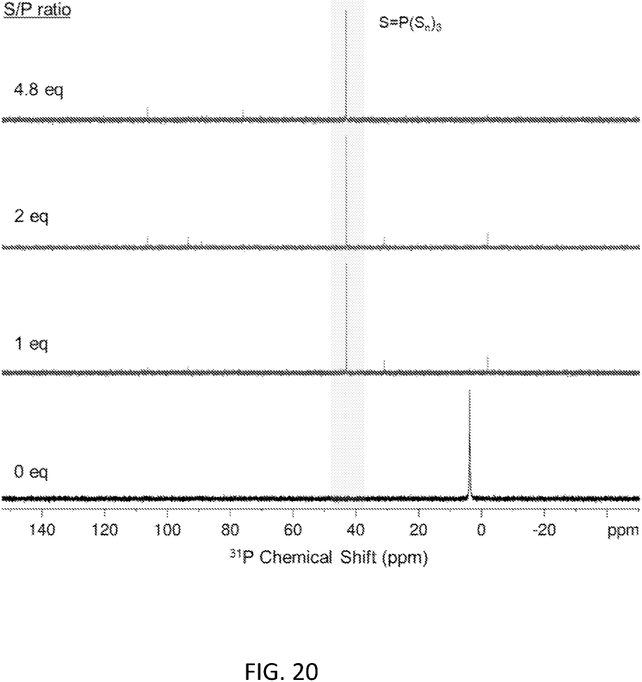

Literature precedent provides that extended thiophosphates (also called polysulfidophosphates) are form by reacting Li₃PS₄ with lithium polysulfide solutions. In the process of developing this synthesis, we found that a preliminary solvent-exchange step with diethyl ether (Et₂O) improved the yield of the UiO-66-OPS powder and mitigated undesirable side reactions of the P—Cl moiety with the carrier solvent (FIGS. 19 and 20). FIG. 19 shows solution phase ³¹P NMR spectra display the results from various PCl₅ + Li₂S₈ reactions, according to embodiment of the present invention. At low S/P ratios (below 15 eq), the P(OR)s feature is observable at + 4 ppm. Adding more equivalents of S eventually result in a sample with a single peak at + 43 ppm. FIG. 20 shows solution phase ³¹P NMR spectra display the reaction solutions from PCl₅ + Li₂S reactions at various stoichiometric S/P ratios, according to an embodiment of the present invention.

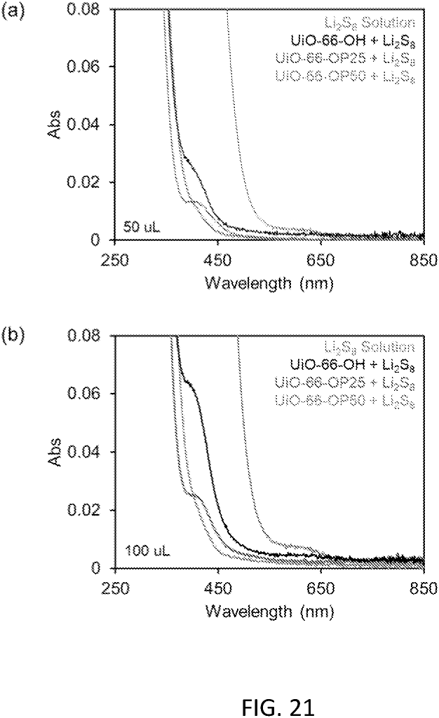

After this solvent exchange step, the lithium polysulfide solution was added to the MOF powder. Different chain lengths and concentrations of lithium polysulfide solutions were explored to assess the ability of the phosphorous group to bind sulfur compounds. We provide spectroscopic evidence of polysulfide uptake using UV-Vis absorbance spectroscopy, wherein aliquot volumes were taken from MOF + Li₂S₈ reaction solutions (FIG. 21). FIG. 21 shows UV-Vis spectra using (a) 50 µL and (b) 100 µL of the MOF + Li₂S₈ reaction solutions after extended soaking, according to embodiments of the present invention. All MOFs remove polysulfides from the loading solution, observed by comparing against the gray “Li₂S₈ Solution” curve. The polysulfide anions S₄²⁻ and S₃^{•-} absorb at 420 nm and 617 nm respectively. We can infer polysulfide uptake by decrease in these absorbances, where the UiO-66-OPx samples demonstrate superior sequestration. In all cases, the solution aliquots from UiO-66-OP25 or UiO-66-OP50 plus Li₂Sₙ reactions exhibit lower absorbances arising from soluble polysulfide anions at 420 nm for S₄²⁻ and 617 nm for S₃^{•-} than the aliquots from the UiO—66—OH + Li₂S₈ control. Further, the UiO—66—OP50 removes more free polysulfide from solution than the UiO-66-OP25, confirming that the phosphorous species is instrumental in polysulfide uptake.

Beyond this ex situ analysis of polysulfide uptake, we also confirm reactivity of PCl₅ with lithium polysulfides by adding increasing volumes of a 40 mM Li₂S₈ solution (in DOL/DME, see Appendix D for preparation) to solid PCl₅. The bright red polysulfide solution immediately bleaches to colorless upon addition to PCl₅, indicative of reaction and in line with our UV-Vis studies. To verify reactivity, the separate reaction solutions containing a range of 0 to 20 molar equivalents of S to P were analyzed by ³¹P NMR spectroscopy (FIG. 19). We note that a side reaction is observed between PCl₅ and DOL/DME that yields a species with chemical shift at + 4 ppm, predominant in solutions where the molar S/P ratio is less than 10 equivalents (FIG. 19). The reaction solution with greater equivalency beyond this point indicates only a single compound is present with a chemical shift of + 43 ppm, that resembles extended thiophosphates (S=P(µ₂-S)₃) including P₄S₁₀ and other glassy compounds in the solid state. Another experiment using solid Li₂S and PCl₅ yields similar results at much lower S/P ratios (FIG. 20) with the species at + 43 ppm as the major product.

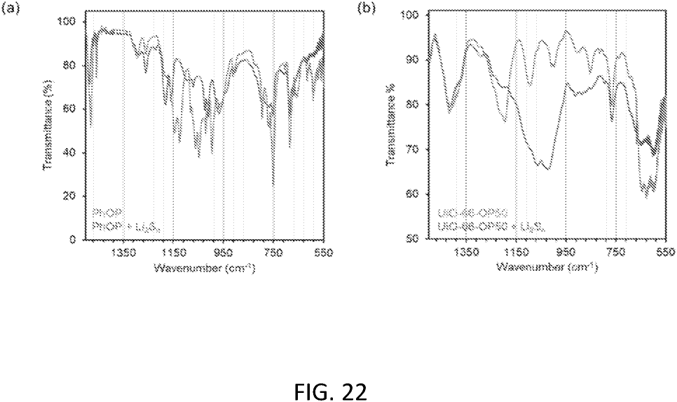

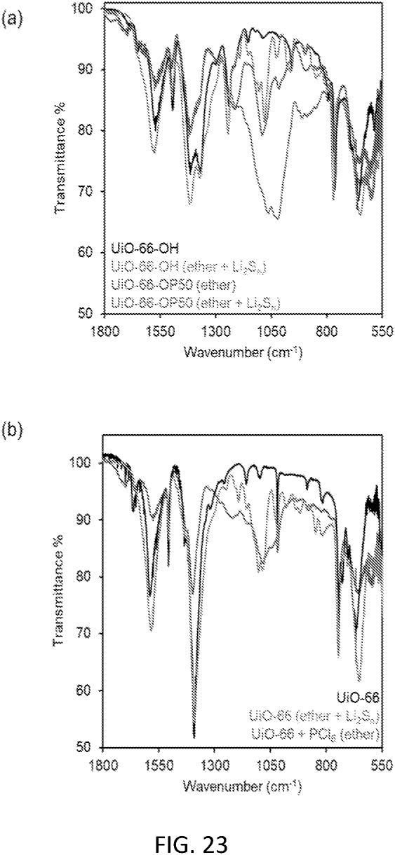

A similar experiment to systematically evaluate ³¹P NMR spectra of the UiO-66-OPS compounds is not feasible, as the extended thiophosphates do not survive the MOF degradation procedure. The infrared spectrum of UiO—66—OPS does show minor changes to previously identified P—O—C and P—Cl stretches from UiO—66—OP50, and weak stretches in the appropriate range for a P═S stretch (FIGS. 22 and 23). FIG. 22 shows a comparison of FT-IR spectra between the (a) molecular and (b) MOF systems before and after the phosphorous compounds are exposed to the polysulfide solution. FIG. 23 shows FT-IR spectra of the (a) UiO—66—OH and (b) UiO—66 series of powders at different stages of functionalization, according to an embodiment of the preset invention. The parent MOF is compared to the P-functionalized product after solvent exchange with ether. Additional spectra of MOFs soaked in polysulfide solutions are also provided.

Peaks of interest are listed in Table 4. Only rough conclusions are attainable from these results as the P-S features are typically weak in infrared spectroscopy. The shifts are reported and compared to analogous peaks observed in our molecular study (Table 4), supporting the binding hypothesis drawn in the above chemical diagram.

Table 4 provides the peak positions and assignments of interest from spectra in FIG. 22. All values are given in cm⁻¹.

TABLE 4

| | PhOP | PhOP + LizSn | UiO-66-OP50 | UiO-66-OP50 + Li₂Sn |
|---|---|---|---|---|
| Ar—O—P symm | 1144, 1124 | 1179, 1157 | 1190 | 1206 |
| Ar—O—P asymm | 912, 904 | 901 | 854 | Hard to see 866? |
| P═S | - | weak 770-750 | - | weak 890-860 |
| P—Cl | 591 | - | 627 | - |

Influence of Linker-Bound Phosphorous on Li-S Electrochemistry: The synthesized MOFs were incorporated into Li—S battery electrodes to evaluate the influence of the various phosphorous moieties on cycling chemistry. Each electrode was prepared by casting a slurry consisting of 45 % S, 30 % MOF, 15 % carbon black (Super-P), and 10 % polymer binder (PVDF) onto a pre-weighed carbon paper disk. After the slurry was dried, the cathode was weighed to determine the mass of sulfur and assembled into coin cells opposite a metallic Li anode. The electrolyte volume was fixed to 60 µL per mg sulfur in the cathode.

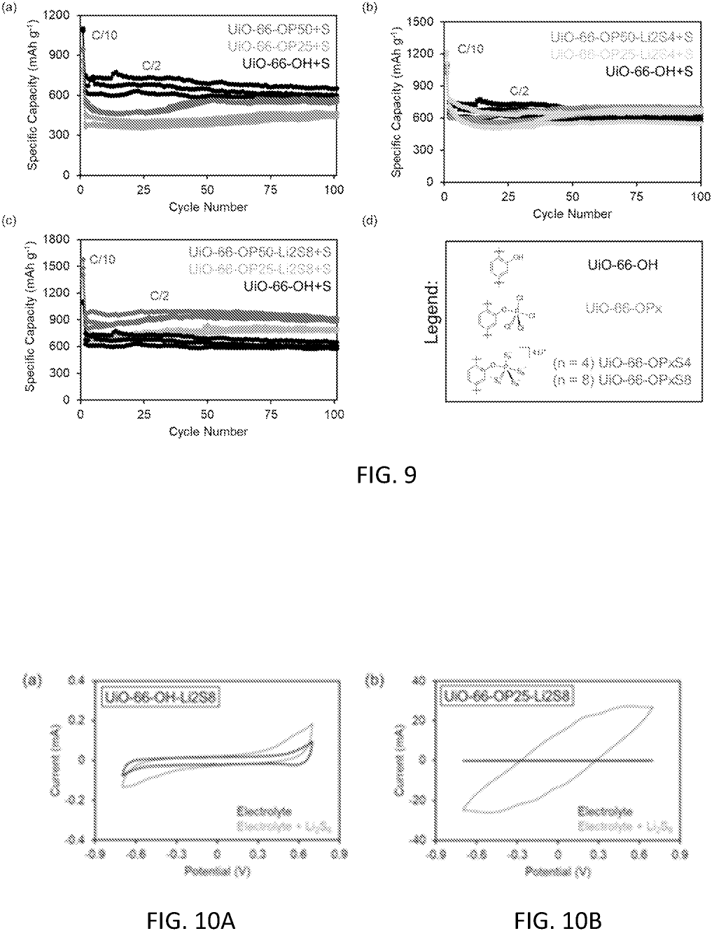

Galvanostatic Cycling Experiments: FIG. 9 shows galvanostatic Li—S cycling results for (a) UiO—66—Px (without added Li₂Sₙ) demonstrates the UiO—66—OP25 and UiO—66—OP50 cells deliver diminished capacity when compared to the control UiO—66—OH cells due polysulfide uptake, (b) for UiO—66—OPx and 10 mM Li₂S₄, (c) for UiO—66—OPx and 40 mM Li₂S₈, according to embodiments of the present invention. In the reaction (a), the capacity retention is excellent and appears to be increasing above 50 cycles. The samples obtained from reaction with (b) UiO—66—OPx and 10 mM Li₂S₄ and (c) UiO—66—OPx and 40 mM Li₂S₈ show similar capacity retention behavior. A portion of the capacity delivered in the polysulfide treated cells could arise from the synthetic procedure.

Our discussion starts with the UiO—66—OPx sample, where the P—Cl groups have not been converted to P—S. Our UV—Vis and NMR experiments demonstrate the P—Cl moiety reacts with soluble polysulfides to form P—S complexes, thus removing utilizable sulfur compounds from the electrochemically available material in the cathode. At least a portion of the sulfides cannot be recovered, as both the UiO—66—OP25 and UiO—66—OP50 cells exhibit lower capacity than the cells constructed with the parentUiO—66—OH sample (plot (a) of FIG. 9). Upon continued cycling, the cells containing UiO—66—OP25 and UiO—66—OP50 do not exhibit capacity decay, but rather increase in capacity over 100 cycles at C/2. The increase in capacity over cycling indicates incorporation of the phosphorous group plays a significant role in limiting polysulfide leaching and assists in accessing sulfur that may not have been utilized in early cycles as suggested by previous studies. The cycling experiments shown in plot (a) of FIG. 9 provide a benchmark for our results, indicating phosphorous incorporation itself (and not addition of lithium polysulfides) is responsible for the improved cycling behavior.

The next sets of battery experiments were designed to examine the functionalized MOFs containing thiolated phosphorous (P—S) moieties. Two different polysulfide solutions (10 mM Li₂S₄ and 40 mM Li₂S₈) were used to incorporate different chain lengths of extended thiophosphate (P—Sₙ) species into the MOF. Battery cycling results for the shorter chain length polysulfide samples (UiO—66—OP25—Li2S4, UiO—66—OP50—Li2S4) in plot (b) of FIG. 9 show both functionalized samples show a small dip in capacity once the rate is shifted from C/10 to C/2, but regain performance over continued cycling. These results indicate some polysulfides formed upon battery cycling may be taken up in early cycles, but seem to be utilized more efficiently in later cycles. Cells containing UiO—66—OP50—Li2S4 recover from this dip region in fewer cycles than the UiO—66—OP25—Li2S4 cells, again suggesting the phosphorous moiety is responsible for enhancing sulfur utilization.

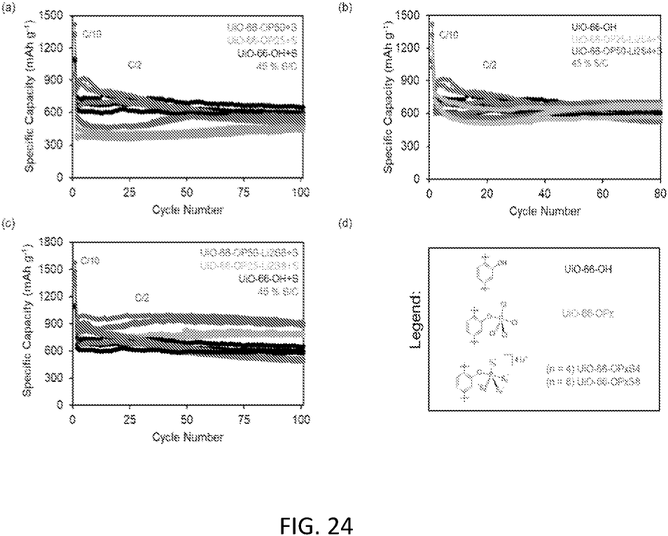

The cycling results from cells containing longer chain length polysulfidophosphates (UiO—66—OP25—Li2S8 and UiO—66—OP50—Li2S8) are shown in plot (c) of FIG. 9. These results illustrate further improvements in sulfur utilization and capacity retention afforded upon thiophosphate functionalization compared to the parent UiO-66-OH cells. While some of this capacity arises from the sulfur molecules introduced from MOF synthesis, as discerned from “noS” control experiments (Table 5), the significant capacity retention over the parent MOF is again achieved. We compare all of our results to conventional sulfur/carbon (S/C) composite cathodes (FIG. 24) and observe the cells containing functionalized MOFs exhibit consistently better cycling performance over 100 cycles. FIG. 24 shows all galvanostatic cycling results compared to the performance of a control 45 % S/C cell that does not contain any MOF additive, according to an embodiment of the present invention.

Table 5 provides initial capacities obtained from cells without added elemental sulfur cycled at a rate of C/10. These results capture the capacity contribution of polysulfides introduced in the synthesis of these samples.

TABLE 5

| “no S” Cell | Initial Capacity C/10 (mAh g⁻¹) |
|---|---|
| UiO—66—OH+Li2S8 | 135 |
| UiO—66—OP25—Li2S4+S | 104 |
| UiO—66—OP50—Li2S4+S | 144 |
| UiO—66—OP25—Li2S8+S | 123 |
| UiO—66—OP50—Li2S8+S | 251 |

The combined electrochemical cycling results highlight the role of the phosphorous species in mitigating capacity fade. Since sulfur atoms are either removed or added in all of these experiments, it is difficult to make definitive statements regarding the effect of phosphorous on sulfur utilization shown in the above paragraphs. However, the fact that UiO—66—OP50 cells deliver higher capacities than the UiO—66—OP25 cells, despite an increased uptake of polysulfides (FIG. 21) that should limit deliverable capacity, signifies phosphorous incorporation does improve S utilization. More electrochemical experiments are provided to test this claim in the next sections.

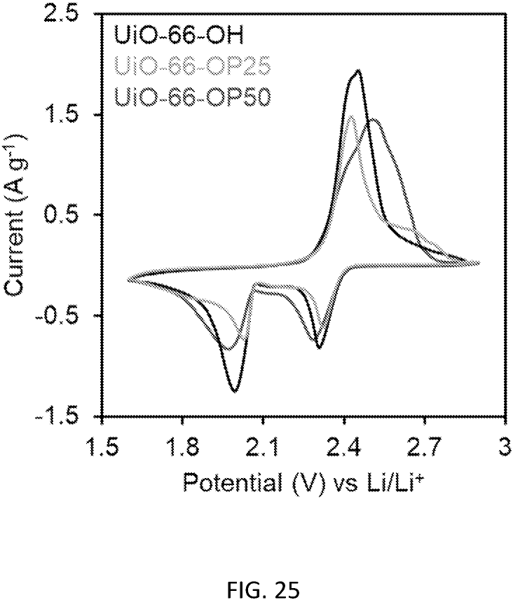

Cyclic Voltammetry Experiments: FIG. 10A shows a cyclic voltammetry experiment conducted on symmetric cells composed of UiO—66—OH—Li₂S₈, according to an embodiment of the present invention. FIG. 10B shows a cyclic voltammetry experiment conducted on symmetric cells composed of UiO—66—OP25—Li₂S₈ electrodes, according to an embodiment of the present invention. The black and grey curves in each graph correspond to the cell before and after addition of Li₂S₆ respectively. We investigate the ability of the functionalized MOFs to improve sulfur utilization using a symmetric cell experiment. Cyclic voltammetry was performed on coin cells where both electrodes were made using a slurry of 60 % carbon, 30 % MOF, and 10 % PVDF binder with nearly identical mass loading. The MOFs were soaked in 40 mM Li₂S₈ solutions and washed according to the synthesis protocol described in Appendix D. The polysulfide-loaded MOF cell is potentiometrically cycled in the electrolyte to establish a baseline current response (FIGS. 10A, 10B, black curve). Afterwards, the cell was opened and reassembled with an electrolyte solution containing 0.25 M Li₂S₆. The results in FIGS. 10A and 10B show the thiophosphate-functionalized MOF gains a large current response with features corresponding to sulfur reduction and oxidation when the Li₂S₆ is added, whereas the parent MOF shows only a small current enhancement. We hypothesize that chemically tethering the polysulfides to the MOF via the BDC-OP linker significantly enhances their electrochemical accessibility, providing the large current enhancement observed here. Additional CV experiments on Li—S cells containingUiO—66—OPx additives (FIG. 25) display characteristic features corresponding to sulfur redox behavior. FIG. 25 shows CV results for cells containing various MOF additives, according to an embodiment of the present invention. The sulfur redox potentials for cells containing UiO-66-OPx are slightly shifted compared to the cells constructed with the parent UiO-66-OH material. There do appear to be slight shifts in the redox potentials for both reductive and oxidative events that define UiO-66-OPx containing cells. We investigate the nature of these differences in the next section.

Additional Electrochemical Analysis: The difference between charge/discharge potentials during cycling, referred to as polarization, is useful to observe electrochemical variations in sulfur redox features. The polarization (ΔV) is quantified by normalizing the galvanostatic charge/discharge curves to state of charge and obtaining the potential difference between these curves at a certain percent of charge. The polarization results at 50 % state of charge for all cells in their 100^{th} cycle are provided in Table 6. Cells containing UiO—66—OPx exhibit slightly higher polarization values than the unfunctionalized or UiO—66—OPx—Li2Sn cells, consistent with our CV experiments, that could be a contributing factor to their limited cycling abilities.

Table 6 provides polarization analysis data of cells examined in this study. ΔV₅₀ values were measured at a 50 % stated of charge for all cells in their 100^{th} cycle at a rate of C/2. The average final capacities are also provided for each entry in the rightmost column.

TABLE 6

| Cell | ΔV₅₀ | Average Capacity 100x C/2 (mAh g⁻¹) |
|---|---|---|
| UiO—66—OH+S | 0.2651 | 604 ± 23 |
| UiO—66—OP25+S | 0.3174 | 454 ± 12 |
| UiO—66—OP50+S | 0.2901 | 561 ± 13 |
| UiO—66—OP50—Li2S4+S | 0.2778 | 689 ± 13 |
| UiO—66—OP25—Li2S8+S | 0.2303 | 785 ± 6 |
| UiO—66—OP50—Li2S8+S | 0.2818 | 901 ± 16 |
| 45 % S/C | 0.2480 | 502 ± 13 |

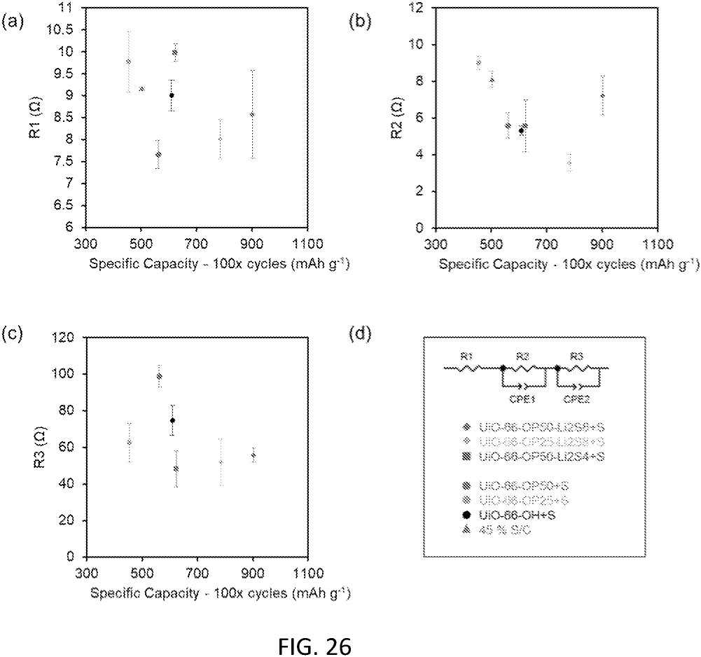

Electrochemical impedance spectroscopy (EIS) results provide insight to electrochemical factors limiting Li—S cycling and supplement our discussion. We model our impedance results obtained from discharged cells after 100x cycles using an equivalent circuit containing three resistors corresponding to electrolyte solution resistance (R1), electrode surface resistance (R2), and charge transfer resistance (R3) as drawn in FIG. 26. FIG. 26 shows compiled EIS results for cells examined in this study, each plotted versus the average final capacities of the cells containing the different MOF additives, according to an embodiment of the present invention. The results for (a) R1 -electrolyte solution resistance, (b) R2 - electrode surface resistance, and (c) R3 - charge transfer resistance are each plotted versus the average final capacities of the cells containing the different MOF additives. An equivalent circuit and legend are provided in panel (d). All EIS results were obtained on cells after cycling in the discharged state. Error bars represent one standard deviation. While the R1 and R2 values may be similar, the R3 value is notably lower for UiO—66—OPx—Li2Sn containing cells than the parent UiO-66-OH or UiO-66-OPx cells. A small R3 value implies there is less of a barrier to maintain polysulfide equilibria during cycling, where both ions and electrons are delivered to sulfur species. Lower charge transfer resistance was also observed from thiophosphate containing symmetric cell compared the unfunctionalized control cell for EIS results obtained after the CV experiment (Table 7). Although R3 values for UiO-66-OPx containing cells are higher than theirUiO—66—OPx—Li2Sn counterparts, the difference is not extreme and is likely only a contributing factor to the overall cell polarization value.

Table 7 provides EIS results obtained from symmetric cells containing MOF composite electrodes. The values were collected after CV experiments were conducted.

TABLE 7

| Cell | R_{S} (Ω) | R_{CT} (Ω) |
|---|---|---|
| UiO—66—OP25—Li2S8 + electrolyte | 5.3 | NA |
| UiO—66—OP25—Li2S8 + electrolyte + Li₂S₆ | 6.5 | 1.2 |
| UiO—66—OH—Li2S8 + electrolyte + Li₂S₆ | 8.0 | 2.6 |

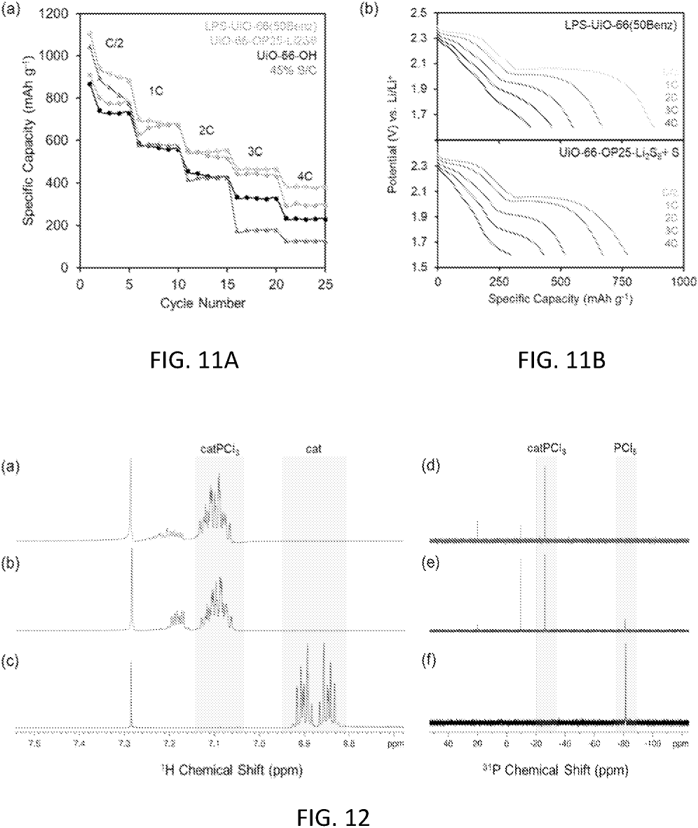

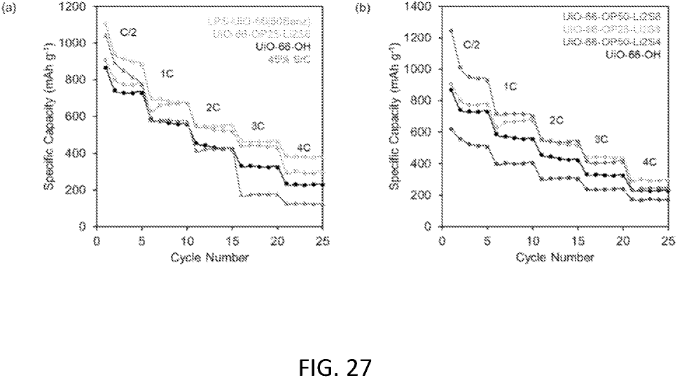

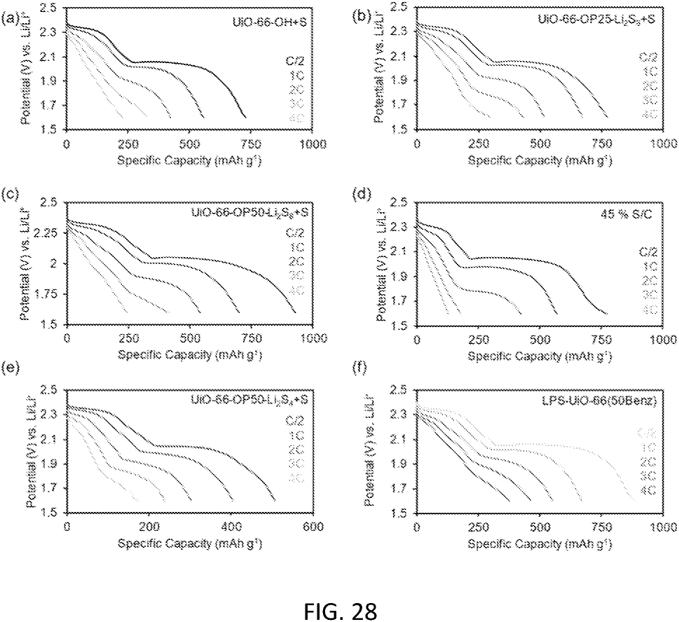

Thiophosphate Influence on Li-S Redox Mechanisms: FIG. 11A shows a rate capability results from C/2 to 4C, according to an embodiment of the present invention. FIG. 11B, shows the fifth cycle’s galvanostatic discharge curve at each C-rate for LPS—UiO—66(50Benz) (top) and UiO—66—OP25—Li₂S₈ (bottom), according to an embodiment of the present invention. At high C-rates, a third feature is seen in the discharge curves around 2.1 V vs Li/Li⁺ for both cells containing thiophosphate functionalized MOFs. Coin cells containing the UiO-66 with the thiophosphate moiety bound to the Zr node exhibited high capacity delivery at fast charge/discharge rates (C-rates). We observe similar capacity delivery for the linker-functionalized frameworks as shown in FIG. 11A. Interestingly, the galvanostatic discharge curves exhibit three plateaus when cycled at C-rates above 1C (FIG. 11B) for both node- and linker-functionalized MOF samples. Additional results and discharge curves are provided in FIGS. 27 and 28, where all cells containing thiophosphate functionalized MOFs, regardless of synthetic method or MOF identity, exhibit this behavior. FIG. 27 shows the rate capabilities for various cells with panel (a) is the same as in FIG. 11A, according to an embodiment of the present invention. FIG. 28 shows in plots (a-f) galvanostatic discharge curves at different C-rates, according to an embodiment of the present invention. Cells containing thiophosphate additives (b, c, e, f) all exhibit a third plateau feature at C-rates above C/2.

The plateau features correspond to discrete Li—S equilibria. Different electrolyte compositions and cycling temperatures have been previously shown to influence which equilibria are favored in Li—S batteries. Since we observe the three-plateau behavior in both thiophosphate functionalized systems and not in any of the parent MOF cells, we attribute this unusual effect to altered Li—S chemistry imparted by the phosphorus moiety.

In the above paragraphs, we present a novel approach to install phosphorane and thiophosphate moieties onto the MOF scaffold using the organic linker as an anchoring support. Spectroscopic evidence collected thus far indicates the phosphorous species is tethered via an aromatic —OH group, forming a strong P—O bond. The phosphorane functionalized MOFs demonstrate an ability to sequester polysulfides from solution, taking up sulfur molecules to displace chlorine ligands and ultimately forming the thiophosphate moiety. While demonstrated here for sulfur capture, this P—Cl group could also be used to bind other guest molecules that form strong linkages with phosphorous with potential applications in separation or gas purification.

The ability of the P—Cl and P—S functionalized materials to capture sulfur compounds is highlighted in Li—S batteries. Batteries prepared with UiO-66-OPx and UiO-66—OPx—Li2Sn show promising capacity retention over extended cycling, and suggest phosphorous is instrumental to mitigate polysulfide leaching phenomena. Several complementary electrochemical techniques confirm the thiophosphate group also enhances sulfur utilization and lowers charge transfer resistance, both key factors to improve the energy storage capabilities of the Li—S device.

The following is supporting information for Thiophosphate-Functionalized Organic Linkers Promote Polysulfide Retention in MOF-Based Li—S Batteries.

Experimental Details: General Characterization: Infrared spectra (FT-IR) were collected using a ThermoScientific Nicolet iS FT-IR with iD 5 ATR attachment. Air exposure for sensitive samples occurs a close to the start of the measurement as possible. X-ray diffraction patterns (XRD) were collected using a Bruker D8 Focus diffractometer with a Cu Kα source and LynxEye detector. Elemental analysis by inductively coupled plasma optical emission spectroscopy (ICP-OES) was performed by Robertson Microlit Laboratories to obtain results in Table 3.

Nuclear Magnetic Resonance (NMR) Spectroscopy: Solution phase ¹H and ³¹P NMR spectra were collected using a 400 MHz Bruker Avance II Spectrometer. Digested MOF samples were prepared by soaking 5 mg of MOF solid in 0.7 mL of an aqueous 1 M NaOH solution for 24 h under inert atmosphere. The solution was transferred to an Ar-charged sample tube fitted with a rubber septum. Other non-MOF spectra were collected in a similar air-free manner, using 1 M NaOH/D₂O unless otherwise noted.

Polysulfide Adsorption UV-Vis Experiments: A volume of 0.75 mL of 10 mM Li₂S₈ was added to 5 mg of ether treated MOF and left to soak overnight. The reaction solution was collected using an air-tight syringe to deliver aliquot volumes to an air-free cuvette containing 2.0 mL DOL/DME solution for UV-Vis analysis. The cuvette was shaken after each aliquot addition.

Synthesis: D.2.1. General Information: Reagents and solvents including N,N-dimethylformamide (DMF) and dichloromethane (DCM) were used as received unless otherwise noted. Solvents used for air-sensitive reactions and electrochemical experiments were distilled over appropriate drying reagents (Na or CaH₂) and stored under Ar before use.

Synthesis of UiO—66—OH: UiO—66—OH was prepared using a modified synthesis based on previous reports. The solid reagents including 1.25 g (5.4 mmol) ZrCl₄ (Strem) and 0.62 g (3.4 mmol) 2-hydroxyterepthalic acid (H₂BDC-OH, TCI) were added to a 250 mL Erlenmeyer flask. We note this is half the quantity of H₂BDC-OH presented in the previous report, needed to make a more defective structure. To this, 120 mL of DMF and 5 mL concentrated HCl (VWR Analytical) were added to form the reaction solution. The flask was transferred to an oven at 80° C. for 24 h once all solids were dissolved. After heating, a white powder is visible in the bottom of the flask. Once cooled, the powder was collected by centrifugation and washed using 8 x 50 mL DMF washes over 3 d to remove unreacted compounds from the MOF powder. The collected powder was then transferred to a glass vial and dried at 100° C. over 24 h. Roughly 1.5 g of MOF powder is collected in a typical synthesis.

Activation of UiO—66—OH: Roughly 300 mg of UiO—66—OH was added to a 50 mL recovery flask for activation. The MOF powder was first chemically activated by repeated soaking/washing with 6 x 20 mL acetone over 3 d, followed by 6 x 20 mL DCM over 3d. The last wash was carefully removed, the flask sealed with a Schlenk adapter, and then evacuated at room temperature for 2 h. This chemical activation step was followed by a thermal activation where the flask was further evacuated while heating at 150° C. for 2 h. The activated UiO—66—OH powder was then stored in Ar filled glovebox.

Synthesis of UiO—66—OPx: All solvents used in the synthesis of UiO—66—OPx were thoroughly dried and degassed before use. The installation of the phosphorous group into the MOF was accomplished using PCl₅ as the binding reagent. In an Ar filled glovebox, 60 mg of activated UiO—66—OH was placed into a pre-weighed vial. The appropriate stoichiometric amount of PCl₅ was calculated based on the theoretical molecular mass of UiO—66—OH using the formula Zr₆(OH)₄(O)₄(C₈H₄O₅)₆ which provides a molar mass of 1759 g mol⁻¹ as demonstrated in the calculation below:

$$\begin{matrix}60 \text{mg} \text{UiO - 66 -} \\ \text{OH} \left(\frac{1 \text{mol} \text{UiO - 66 - OH}}{1759 \text{g}}\right) \left(\frac{6 \text{mol} \text{BDC - OH}}{1 \text{mol} \text{UiO - 66 - OH}}\right) \\ \left(\frac{208 {\text{g PCl}}_{5}}{1 \text{mol} {\text{PCl}}_{5}}\right) = 43 \text{mg} {\text{PCl}}_{5}\end{matrix}$$

This amount of PCl₅ represents 1 stochiometric equivalent. The desired mass of PCl₅ (Beantown Chemical) was dissolved in DCM to make a 0.2 M solution, requiring several minutes to completely dissolve. The colorless PCl₅—DCM solution was added to the UiO—66—OH powder and thoroughly mixed. Some release of HCl is observed after addition of the solution. The reaction takes place as the solution infiltrates the MOF over 2 h in the glovebox, resulting in a yellow powder. Using 2 or 4 equivalents of PCl₅ yields roughly 25 % or 50 % conversion of BDC—OH to BDC—OP. Afterwards, the majority of the reaction solution is removed, followed by repeated washing with 6 x 2 mL DCM to remove unreacted PCl₅. After the last wash, residual solvent is removed in vacuo yielding roughly 70 - 80 mg of collected UiO—66—OPx. The amount of phosphorous incorporated was determined by digestion and analysis of ¹H spectroscopy to quantify the relative extent of BDC-OH and BDC-OP in the sample (Table 1).

Synthesis of UiO—66—OPx—Li₂Sn: In our synthesis development, we struggled to find compatible solvents for both P—Cl and lithium polysulfide solutions to accomplish the P—Cl to P—S transformation. Solvents were evaluated in their reactivity with PCl₅ using ³¹P NMR spectroscopy where it was found no reaction occurred with DCM, diethyl ether (Et₂O), and hexanes, however reactivity was observed with DOL and acetonitrile (MeCN). To avoid reaction with DOL, the UiO—66—OPx powder was first solvent-exchanged with EtzO to pre-fill the MOF pores with a solvent compatible with the Li₂Sₙ solution (DCM causes bleaching of polysulfide solutions). To 30 mg of this washed powder, 1.0 mL of a 10 mM solution of Li₂S₄ prepared in a 1:1 DOL to DME mixture (v:v) was added and was left soaking for 1 h to form UiO—66—OPx—Li₂S₄. The lithium polysulfide solution transitions from an olive-green color to very slight yellow over the soaking period. After soaking, the polysulfide loading solution is removed and the resulting powder is washed at least 4 x 2 mL DOL, affording ca. 28 mg of cream-colored UiO—66—OPx—Li₂S₄ powder.

The procedure to synthesize UiO—66—OPx—Li₂S₈ is identical, however 0.25 mL of the 40 mM Li₂S₈ solution was added to UiO—66—OPx powder to adjust for concentration differences. This approach was used to synthesize UiO—66—OH+Li₂S₈ used in the symmetric cell CV experiment.

Synthesis of Li₂Sₙ Solutions: The lithium polysulfide solutions used in this study were prepared following the guidelines of a previous report.² We use a DOL/DME solution for all of these preparations consisting of 1:1 mixture of 1,3-dioxolane (DOL, Acros Organics) and 1,2-dimethoxyethane (DME, Alfa Aesar) by volume.

A 10 mM solution of Li₂S₄ was prepared by adding stoichiometric amounts of Li₂S (Strem) and elemental sulfur (Sigma) in the molar ratio 1:3. An appropriate volume of the DOL/DME solution was added to the solids to make the 10 mM solution. The solution develops a yellow-green color over 1 week. The 40 mM Li₂S₈ solution was prepared in an analogous manner, adding Li₂S and sulfur in a ratio of 1:7. The same DOL/DME solution was used and is dark-red after 1 week.

Additional Control Reactions: D.3.1. UiO-66 + PCl₅: 43 mg of PCl₅ was dissolved in DCM to make a 0.2 M solution. The solution was added to 30 mg activated UiO—66 in an Ar filled glovebox and allowed to soak for 24 h. The resulting white powder was separated from the reaction solution and washed with DCM as described in section D.2.4 above.

Na₂BDC—OH + PCI₅: A Na₂BDC—OH salt was prepared by reacting 2 equivalents of NaOH with H₂BDC—OH in deionized water. A pale-yellow solid was collected from the residue after the water was removed using an 80° C. oven. The salt was further dried at 120° C. under reduced pressure and then brought into an Ar filled glovebox for use. Approximately 30 mg of Na₂BDC—OH (0.13 mmol) and 32 mg PCl₅ (0.15 mmol) were added to a vial along with 4 mL DCM. The solids did not all dissolve, but the reaction solution turned slightly yellow after 48 h of reaction. If the reaction is left longer (> 3 weeks), a bright orange colored solution is obtained and yields the NMR spectra shown in FIGS. 7A, 7B and 7C.

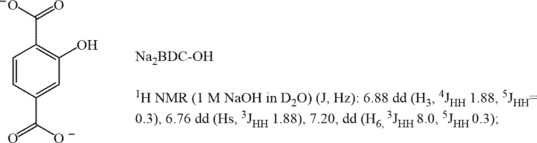

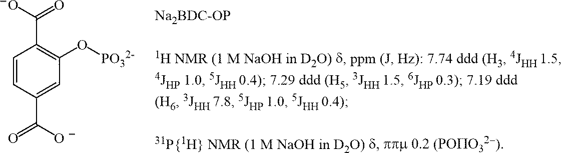

Catechol + PCl₅

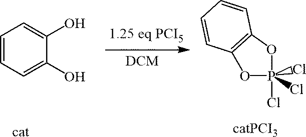

Catechol (cat) was recrystallized from DCM before use. In our small-scale synthesis, 10.0 mg (0.091 mmol) of cat and 23.9 mg PCl₅ (0.115 mmol) were each dissolved in 1.0 mL DCM under Ar atmosphere. We used this slight excess of PCl₅ (~ 1.25 eq) to favor lesser substituted products.³The catechol solution was added dropwise to the PCl₅ solution with stirring and then left overnight. Afterwards, the volatiles were removed under vacuum and yielded 26.1 mg of a white powder. A single recrystallization from hexane removed PCl₅ from the product mixture (FIG. 12). Further isolation of the substituted products is possible via vacuum distillation³but was not attempted on this small-scale reaction.

Phenol + PCl₅: In an Ar atmosphere, a 0.2 M stock solution of phenol (PhOH) was prepared in DCM and added to vials containing various amounts of solid PCl₅ to achieve the PhOH:PCl₅ molar ratios from 1:8 to 6:1. Each solution remains colorless throughout the 24 h reaction period and no precipitate is observed. The solvent was removed under vacuum, leaving a white residual powder. The powders were dissolved in 1 M NaOH/D₂O for NMR analysis (FIGS. 13 and 14).

Li₂S₈ or Li₂S + PCl₅ for NMR Studies: In each of these reactions, 10.0 mg of PCl₅ (0.05 mmol) was added to a separate vial. Calculated volumes of a 40 mM Li₂S₈ solution (see section D.1.6 for preparation) were added to the PCl₅ solid, resulting an instantaneous reaction. The solutions were allowed to equilibrate over 24 h before analysis by ³¹P NMR (FIG. 19). The procedure for reactions of PCl₅ and Li₂S were slightly different as Li₂S is insoluble in most solvents. Roughly 10 mg of solid PCl₅ and 2.3 mg, 4.3 mg, or 11.2 mg Li₂S depending on desired stoichiometry (1, 2, 5 eq) were added to a vial along with 2.0 mL DOL and left stirring in Ar atmosphere overnight. Resulting solutions were examined by ³¹P NMR spectroscopy shown in FIG. 20.

Electrochemistry; Instrumentation: Coin cells were cycled galvanostatically using a battery analyzer workstation (MNT-BA-5 V, MicroNanoTools) after resting for 8 h. All cells were first charged and discharged at C/10 (168 mA g⁻¹) to “prime” the cell, followed by 100 x cycles at C/2 unless otherwise noted. Cyclic voltammetry (CV) experiments were collected using an Ivium-n-STAT multichannel electrochemical analyzer. Freshly prepared coin cells with MOF composite cathodes were used for CV experiments. The cells were allowed to rest a minimum of 8 h, then cycled at a scan rate of 0.1 mV s-1 between 2.9 and 1.6 V vs Li/ Li+. Electrochemical impedance spectroscopy (EIS) results were also obtained using an Ivium-n-STAT multichannel electrochemical analyzer. The AC current amplitude was 10 mV, where the frequency was varied from 1 MHz to 0.1 Hz at the cell’s open circuit potential. Cells were examined in the discharged state after 100x cycles at C/2 unless otherwise noted.

Coin Cell Preparation: Composite sulfur cathodes were prepared using a slurry recipe of 45 % S, 30 % MOF, 15 % Super-P carbon black (Alfa Aesar), and 10 % poly(vinylidene fluoride) (PVDF, Alfa Aesar) by mass. The solids were suspended in DME and vortexed for ~ 30 min to homogenize the slurry to a honey-like consistency. The slurries were cast onto pre-weighed carbon paper disks (½″ diameter) and dried at room temperature over 8 h. All slurries and cathodes except 45 % S/C and UiO—66—OH controls were prepared in an Ar filled glovebox.

Size 2032 coin cells were assembled in an Ar filled glovebox by sandwiching the composite cathode, two Celgard separators, and a metallic lithium between two stainless steel spacers and a conical spring. The electrolyte formulation was 1.0 M lithium bis(trifluoromethanesulfonyl)imide (LiTFSI, Oakwood Chemical) in a 1:1 volume mixture of DOL/DME with an additional 2 % LiNO₃ (Strem) by mass. The electrolyte volume was fixed to 60 µL per mg S in the cathode. Constructed cells were allowed to rest a minimum of 8 h before each experiment.

Symmetric Cell CV Experiment: Solid amounts of Li₂S (0.25 mmol) and S (1.25 mmol) were added to 1.0 mL of the prepared electrolyte solution used for other cycling experiments (1 M LiTFSI in an equal-volume mixture of DOL and DME, with added 2 % LiNO₃ by mass) to prepare a 0.25 M Li₂S₆ solution. The prepared solution was red-brown in color after 3 days.

Electrodes were prepared by coating a slurry consisting of 30 % MOF, 60 % Super-P carbon black, and 10 % PVDF binder by mass over pre-weighed carbon paper disks in an Ar-filled glovebox. After drying, the electrodes were weighted, and the mass of MOF was determined. Two electrodes with nearly identical masses of MOF material were selected to ensure the constructed cells were as symmetric as possible. A size 2032 coin cell was constructed with these two electrodes, separated by two Celgard separators, and 50 µL of the polysulfide-free electrolyte. This cell was allowed to rest for a minimum of 4 hours and then cycled voltametrically from -0.7 V to + 0.7 V at 50 mV s⁻¹ with the scan starting at 0.0 V. Three scans were collected to ensure no electrode “wetting” phenomena obscured the CV results.

The cell was deconstructed in an Ar atmosphere, taking care to preserve the electrodes and separator components. Another coin cell was assembled using these recovered components, except now with addition of 50 µL of the 0.25 M Li₂S₆ in electrolyte solution. The cell was cycled as described for the previous polysulfide-free cell above.

Reaction Scheme 1: Possible reaction products from PCl₅ and catechol and their tentative assignments based on previous reports.

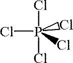

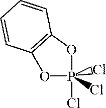

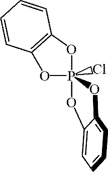

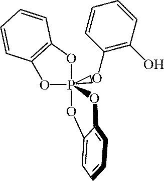

Table 8 provides the relative concentration of the various species PCl₅, catPCl₃, cat₂PCl, in the above reaction scheme, according to an embodiment of the present invention

TABLE 8

| Species | ³¹P δ (ppm) |
|---|---|
| PCl₅ | -81 |
| catPCl₃ | -26 |
| cat₂PCl | -9 |
| cat₃P | + 20 |

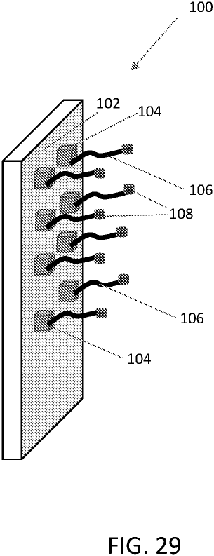

As it can be appreciated from the above paragraphs, there is provided electrode including at least one of sulfur (S) or selenium (Se); and a functionalized metal organic framework (R-MOF). FIG. 29 shows schematically an electrode 100, according to an embodiment of the present invention. The electrode 100 has at least one of sulfur (S) or selenium (Se) 102; and a functionalized metal organic framework (R-MOF) 104. The functionalized metal organic framework (R-MOF) 104 has a functional group (R) attached to an organic portion of a metal organic framework (MOF). The functionalized metal organic framework (R-MOF) 104 is adapted to react with at least one of electrochemically accessible sulfur (S) or selenium (Se) to capture at least one of lithium polysulfide or sodium polysulfide 106 via covalent attachment of sulfur (S) or selenium (Se), respectively, to the functional group (R) of the functionalized metal organic framework (R-MOF) 104. The R-MOF 104 and the covalent attachment of sulfur or selenium to the functional group R of the R-MOF 104 are described in the above paragraphs in detail with reference to FIG. 1, for example. The lithium or sodium 108 are associated with the sulfur in the lithium polysulfide or sodium polysulfide 106.

In an embodiment, the functionalized metal organic framework (R-MOF) has pores and at least one of selenium (Se) or the sulfur (S) is deposited within the pores. In another embodiment, the functionalized metal organic framework (R-MOF) and at least one of selenium (Se) or the sulfur (S) can be mixed together. In an embodiment, the metal organic framework (MOF) can be any one of UiO—66, MOF—808, and NU—1000.

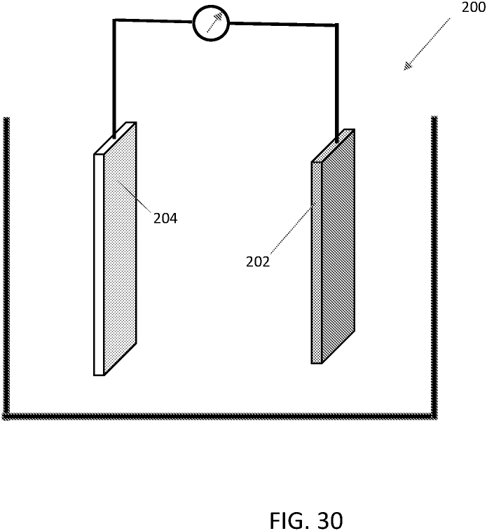

FIG. 30 shows schematically an electric battery 200, according to an embodiment of the present invention. The electric battery 200 includes an anode 202 having lithium or sodium and a cathode 204. The cathode 204 includes at least one of sulfur (S) or selenium (Se), and a functionalized metal organic framework (R-MOF). The functionalized metal organic framework (R-MOF) has a functional group (R) attached to an organic portion of the metal organic framework (MOF). The functionalized metal organic framework (R-MOF) is adapted to react with at least one of electrochemically accessible sulfur (S) or selenium (Se) to capture at least one of lithium polysulfide or sodium polysulfide via covalent attachment of sulfur (S) or selenium (Se), respectively, to the functional group of the functionalized metal organic framework (MOF). For example, the cathode 204 can be similar to the electrode 100 shown in FIG. 1. The shuttling of dissolved lithium polysulfides (e.g., Li₂Sₓ) or sodium polysulfides away from the cathode 204 to the anode 202 during cycling is known as the shuttle effect. The use of the present cathode 204 in battery 200 prevents this effect.

In an embodiment, the functional group (R) may include a maleimide (Mi) functional group. In an embodiment, the functional group (R) can include a thiophosphate (PSₓ), a thiogermanate (GeSₓ), a thioarsenate (AsSₓ) functional group, a selenophosphate (PSeₓ), a selenogermanate (GeSeₓ), or a selenoarsenate (AsSeₓ) functional group.

In an embodiment, the functionalized metal organic framework (R-MOF) includes pores and at least one of selenium (Se) or the sulfur (S) is deposited within the pores or the functionalized metal organic framework (R-MOF) and at least one of selenium (Se) or the sulfur (S) are mixed together.

In an embodiment, at least one of sulfur (S) or selenium (Se) is present in a proportion of 40 wt% to 90 wt% and the functionalized metal organic framework (MOF) is present in a proportion of 0.1 wt% to 30 wt%.

In an embodiment, the metal organic framework (MOF) includes zirconium, hafnium, cesium, copper, zinc, titanium, iron, vanadium, molybdenum, niobium, or chromium metal ions. In an embodiment, the metal organic framework (MOF) can be any one of UiO—66, MOF—808 and NU—1000.

In an embodiment, the functional group (R) of the functionalized metal organic framework (R-MOF) is adapted to covalently react with the lithium polysulfide or sodium polysulfide to capture the lithium polysulfide or the sodium polysulfide.

In an embodiment, the lithium polysulfide can include Li₂Sₓ, where x = 1 to 8. In an embodiment, the sodium polysulfide can include Na₂Sₓ, where x = 1 to 8.

### REFERENCES AND NOTES

1. P. G. Bruce, S. A. Freunberger, L. J. Hardwick and J.-M. Tarascon, Nat. Mater., 2012, 11, 19-29.
2. A. Manthiram, Y. Fu, S.-H. Chung, C. Zu and Y.-S. Su, Chem. Rev., 2014, 114, 11751-11787.
3. K. Sun, N. Li, D. Su and H. Gan, J. Electrochem. Soc., 2019, 166, A50-A58.
4. A. Rosenman, E. Markevich, G. Salitra, D. Aurbach, A. Garsuch and F. F. Chesneau, Adv. Energy Mater., 2015, 5, 1-21.
5. H. Bin Wu and X. W. Lou, Sci. Adv., 2017, 3, 1-17.
6. A. E. Baumann, D. A. Burns, B. Liu and V. S. Thoi, Commun. Chem., 2019, 2, 86.
7. J. Zhou, R. Li, X. Fan, Y. Chen, R. Han, W. Li, J. Zheng, B. Wang and X. Li, Energy Environ. Sci., 2014, 7, 2715.
8. H. Jiang, X.-C. Liu, Y. Wu, Y. Shu, X. Gong, F.-S. Ke and H. Deng, Angew. Chemie Int. Ed., 2018, 57, 3916-3921.
9. R. Demir-Cakan, M. Morcrette, F. Nouar, C. Davoisne, T. Devic, D. Gonbeau, R. Dominko, C. Serre, G. Ferey and J. M. Tarascon, J. Am. Chem. Soc., 2011, 133, 16154-16160.
10. H. Park and D. J. Siegel, Chem. Mater., 2017, 29, 4932-4939.
11. Z. Wang, B. Wang, Y. Yang, Y. Cui, Z. Wang, B. Chen and G. Qian, ACS Appl. Mater. Interfaces, 2015, 7, 20999-21004.
12. A. E. Baumann, G. E. Aversa, A. Roy, M. L. Falk, N. M. Bedford and V. S. Thoi, J. Mater. Chem. A, 2018, 6, 4811-4821.
13. X.-F. Liu, X.-Q. Guo, R. Wang, Q.-C. Liu, Z.-J. Li, S.-Q. Zang and T. C. W. Mak, J. Mater. Chem. A, 2019, 7, 2838-2844.
14. S. M. Heilmann and J. K. Rasmussen, in Comprehensive Heterocyclic Chemistry, Elsevier, 1st edn., 1984, pp. 269-315.
15. J. H. Park, K. M. Choi, D. K. Lee, B. C. Moon, S. R. Shin, M.-K. Song and J. K. Kang, Nat. Publ. Gr., 2016, 6, 25555.
16. A. E. Baumann, X. Han, M. M. Butala and V. S. Thoi, J. Am. Chem. Soc., 2019, 141, 17891-17899.
17. D. R. Deng, F. Xue, C.-D. Bai, J. Lei, R. Yuan, M. Sen Zheng and Q. F. Dong, ACS Nano, 2018, 12, 11120-11129.
18. Y.-A. Li, C.-W. Zhao, N.-X. Zhu, Q.-K. Liu, G.-J. Chen, J.-B. Liu, X.-D. Zhao, J.-P. Ma, S. Zhang and Y.-B. Dong, Chem. Commun., 2015, 51, 17672-17675.
19. B. D. Mather, K. Viswanathan, K. M. Miller and T. E. Long, Prog. Polym. Sci., 2006, 31, 487-531.
20. T. N. Gevrek, T. Bilgic, H.-A. Klok and A. Sanyal, Macromolecules, 2014, 47, 7842-7851.
21. S. S. Nagane, S. S. Kuhire, U. A. Jadhav, S. A. Dhanmane and P. P. Wadgaonkar, J. Polym. Sci. Part A Polym. Chem., 2019, 57, 630-640.
22. P. Gobbo, M. C. Biesinger and M. S. Workentin, Chem. Commun., 2013, 49, 2831.
23. D. P. Nair, M. Podgórski, S. Chatani, T. Gong, W. Xi, C. R. Fenoli and C. N. Bowman, Chem. Mater., 2014, 26, 724-744.
24. A. Kamimura, N. Murakami, F. Kawahara, K. Yokota, Y. Omata, K. Matsuura, Y. Oishi, R. Morita, H. Mitsudera, H. Suzukawa, A. Kakehi, M. Shirai and H. Okamoto, Tetrahedron, 2003, 59, 9537-9546.
25. Y. Yoshida and T. Endo, Polym. Chem., 2016, 7, 6770-6778.
26. S. Girouard, M.-H. Houle, A. Grandbois, J. W. Keillor and S. W. Michnick, J. Am. Chem. Soc., 2005, 127, 559-566.
27. J. Wu, S. Sun and B. M. Novak, J. Appl. Polym. Sci., 2019, 48909, 48909.
28. M. Fantauzzi, B. Elsener, D. Atzei, A. Rigoldi and A. Rossi, RSC Adv., 2015, 5, 75953-75963.
29. Cavka, J. H.; Jakobsen, S.; Olsbye, U.; Guillou, N.; Lamberti, C.; Bordiga, S.; Lillerud, K. P. J. Am. Chem. Soc. 2008, 6 (42), 13850-13851.
30. Shearer, G. C.; Chavan, S.; Bordiga, S.; Svelle, S.; Olsbye, U.; Lillerud, K. P. Chem. Mater. 2016, 28 (11), 3749-3761.
31. Shearer, G. C.; Vitillo, J. G.; Atzori, C.; Bonino, F.; Bordiga, S.; Svelle, S.; Lillerud, K. P. Chem. Mater. 2016, 28 (20), 7190-7193.
32. Katz, M. J.; Brown, Z. J.; Colón, Y. J.; Siu, P. W.; Scheidt, K. a; Snurr, R. Q.; Hupp, J. T.; Farha, O. K. Chem. Commun. 2013, 49 (82), 9449-9451.
33. Biswas, S.; Van Der Voort, P. Eur. J. Inorg. Chem. 2013, 12, 2154-2160.
34. Byrd, H.; Bharara, P. C.; Sullens, T. A.; Harden, J. D.; Gray, G. M. Inorganica Chim. Acta 2002, 338, 240-244.
35. Ramirez, F.; Bigler, A. J.; Smith, C. P. Tetrahedron 1968, 24 (14), 5041-5051.
36. Rauh, R. D.; Shuker, F. S.; Marston, J. M.; Brummer, S. B. J. Inorg. Nucl. Chem. 1977, 39 (10), 1761-1766.
37. Baumann, A. E.; Han, X.; Butala, M. M.; Thoi, V. S. J. Am. Chem. Soc. 2019, 141 (44), 17891-17899.
38. Taddei, M.; Costantino, F.; Marmottini, F.; Comotti, A.; Sozzani, P.; Vivani, R. Chem. Commun. 2014, 50 (94), 14831-14834.
39. Yabushita, M.; Li, P.; Islamoglu, T.; Kobayashi, H.; Fukuoka, A.; Farha, O. K.; Katz, A. SInd. Eng. Chem. Res. 2017, 56 (25), 7141-7148.
40. Trickett, C. A.; Osborn Popp, T. M.; Su, J.; Yan, C.; Weisberg, J.; Huq, A.; Urban, P.; Jiang, J.; Kalmutzki, M. J.; Liu, Q.; Baek, J.; Head-Gordon, M. P.; Somorjai, G. A.; Reimer, J. A.; Yaghi, O. M. Nat. Chem. 2018, 11, 170-176.
41. Rhauderwiek, T.; Zhao, H.; Hirschle, P.; Doblinger, M.; Bueken, B.; Reinsch, H.; De Vos, D.; Wuttke, S.; Kolb, U.; Stock, N. Chem. Sci. 2018, 222, 5467-5478.
42. Nielsen, M. L.; Pustinger, J. V.; Strobel, J. J. Chem. Eng. Data 1964, 9 (2), 167-170.
43. Socrates, G. Infrared and Raman Characteristic Group Frequencies. Tables and Charts; 3rd ed., John T. Wiley & Sons: Chichester, U. K., 2001.
44. Tanibata, N.; Tsukasaki, H.; Deguchi, M.; Mori, S.; Hayashi, A.; Tatsumisago, M. A J. Mater. Chem. A 2017, 5 (22), 11224-11228.
45. Lin, Z.; Liu, Z.; Fu, W.; Dudney, N. J.; Liang, C. Angew. Chem. Int. Ed. Engl. 2013, 52 (29), 7460-7463.
46. Bieker, G.; Diddens, D.; Kolek, M.; Borodin, O.; Winter, M.; Bieker, P.; Jalkanen, K. J. Phys. Chem. C 2018, 122 (38), 21770-21783.
47. Zou, Q.; Lu, Y. C. J. Phys. Chem. Lett. 2016, 7 (8), 1518-1525.
48. Youngman, R. Materials, 2018, 11, 476.
49. Lin, Z.; Liu, Z.; Fu, W.; Dudney, N. J.; Liang, C. Adv. Funct. Mater. 2013, 23 (8), 1064-1069.
50. Lin, Z.; Liu, Z.; Dudney, N. J.; Liang, C. ACS Nano 2013, 7 (3), 2829-2833.
51. Yuan, Z.; Peng, H. J.; Hou, T. Z.; Huang, J. Q.; Chen, C. M.; Wang, D. W.; Cheng, X. B.; Wei, F.; Zhang, Q. Nano Lett. 2016, 16 (1), 519-527.
52. Zhou, J.; Liu, X.; Zhu, L.; Zhou, J.; Guan, Y.; Chen, L.; Niu, S.; Cai, J.; Sun, D.; Zhu, Y.; Du, J.; Wang, G.; Qian, Y. Joule 2018, 2 (12), 2681-2693.
53. Lin, H.; Yang, L.; Jiang, X.; Li, G.; Zhang, T.; Yao, Q.; Zheng, G. W.; Lee, J. Y. Energy Environ. Sci. 2017, 10 (6), 1476-1486.
54. Deng, Z.; Zhang, Z.; Lai, Y.; Liu, J.; Li, J.; Liu, Y. J. Electrochem. Soc. 2013, 160 (4), A553-A558.
55. Canas, N. A.; Hirose, K.; Pascucci, B.; Wagner, N.; Friedrich, K. A.; Hiesgen, R. Electrochim. Acta 2013, 97, 42-51.
56. Mikhaylik, Y. V; Akridge, J. R. Low Temperature Performance of Li -S Batteries. 2003, J. Electrochem. Soc. 2003, 150, 306-311.
57. Katz, M. J.; Brown, Z. J.; Colón, Y. J.; Siu, P. W.; Scheidt, K. a; Snurr, R. Q.; Hupp, J. T.; Farha, O. K. Chem. Commun. 2013, 49 (82), 9449-9451.
58. Babu, G.; Masurkar, N.; Al Salem, H.; Arava, L. M. R. J. Am. Chem. Soc. 2017, 139 (1), 171-178.
59. Ramirez, F.; Bigler, A. J.; Smith, C. P. Tetrahedron 1968, 24 (14), 5041-5051.
60. Dillon, K. B.; Reeve, R. N.; Waddington, T. C. J. Chem. Soc. Dalt. Trans. 1978, No. 11, 1465-1471.
61. Baumann, A. E.; Han, X.; Butala, M. M.; Thoi, V. S. J. Am. Chem. Soc. 2019, 141
(44), 17891-17899.
62. Zou, Q.; Lu, Y. C. J. Phys. Chem. Lett. 2016, 7 (8), 1518-1525.
63. Bieker, G.; Diddens, D.; Kolek, M.; Borodin, O.; Winter, M.; Bieker, P.; Jalkanen, K. J. Phys. Chem. C 2018, 122 (38), 21770-21783. https://doi.org/10.1021/acs.jpcc.8b06560.
64. Yuan, Z.; Peng, H. J.; Hou, T. Z.; Huang, J. Q.; Chen, C. M.; Wang, D. W.; Cheng, X. B.; Wei, F.; Zhang, Q. Nano Lett. 2016, 16 (1), 519-527. https://doi.org/10.1021/acs.nanolett.5b04166.
65. Zhou, J.; Liu, X.; Zhu, L.; Zhou, J.; Guan, Y.; Chen, L.; Niu, S.; Cai, J.; Sun, D.; Zhu, Y.; Du, J.; Wang, J.; Yitai Qian, Y. Joule 2018, 2 (12), 2681-2693.

The embodiments illustrated and discussed in this specification are intended only to teach those skilled in the art how to make and use the invention. In describing embodiments of the invention, specific terminology is employed for the sake of clarity. However, the invention is not intended to be limited to the specific terminology so selected. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

We claim:

1. An electrode comprising:
at least one of sulfur (S) or selenium (Se); and
a functionalized metal organic framework (R-MOF), the functionalized metal organic framework (R-MOF) having a functional group (R) attached to an organic portion of a metal organic framework (MOF),
wherein the functionalized metal organic framework (R-MOF) is adapted to react with at least one of electrochemically accessible sulfur (S) or selenium (Se) to capture at least one of lithium polysulfide or sodium polysulfide via covalent attachment of sulfur (S) or selenium (Se), respectively, to the functional group (R) of the functionalized metal organic framework (R-MOF).

2. The electrode according to claim 1, wherein the functional group (R) comprises a Maleimide (Mi) functional group.

3. The electrode according to claim 1, wherein the functional group (R) comprises a thiophosphate (PSₓ), a thiogermanate (GeSₓ), or a thioarsenate (AsSₓ) functional group.

4. The electrode according to claim 1, wherein the functional group (R) comprises a selenophosphate (PSeₓ), a selenogermanate (GeSeₓ), or a selenoarsenate (AsSeₓ) functional group.

5. The electrode according to claim 1, wherein the functionalized metal organic framework (R-MOF) comprises pores and the at least one of the selenium (Se) or the sulfur (S) is deposited within said pores.

6. The electrode according to claim 1, wherein the functionalized metal organic framework (R-MOF) and the at least one of selenium (Se) or the sulfur (S) are mixed together.

7. The electrode according to claim 1, wherein the at least one of sulfur (S) or selenium (Se) is present in a proportion of 40 wt% to 90 wt% and the functionalized metal organic framework (R-MOF) is present in a proportion of 0.1 wt% to 30 wt%.

8. The electrode according to claim 1, wherein the metal organic framework (MOF) comprises zirconium, hafnium, cesium, copper, zinc, titanium, iron, vanadium, molybdenum, niobium, or chromium metal ions.

9. The electrode according to claim 8, wherein the metal organic framework (MOF) is selected from the group consisting of UiO-66, MOF-808 and NU-1000.

10. The electrode according to claim 1, wherein the functional group (R) of the functionalized metal organic framework (R-MOF) is adapted to covalently react with the lithium polysulfide or sodium polysulfide to capture the lithium polysulfide or the sodium polysulfide.

11. The electrode according to claim 1, wherein the lithium polysulfide comprises Li₂Sₓ.

12. The electrode according to claim 1, wherein the sodium polysulfide comprises Na₂Sₓ.

13. An electric battery comprising:
an anode comprising lithium or sodium;
a cathode comprising:
at least one of sulfur (S) or selenium (Se); and
a functionalized metal organic framework (R-MOF), the functionalized metal organic framework (R-MOF) having a functional group (R) attached to an organic portion of the metal organic framework (MOF),
wherein the functionalized metal organic framework (R-MOF) is adapted to react with at least one of electrochemically accessible sulfur (S) or selenium (Se) to capture at least one of lithium polysulfide or sodium polysulfide via covalent attachment of sulfur (S) or selenium (Se), respectively, to the functional group of the functionalized metal organic framework (MOF).

14. The electric battery according to claim 13, wherein the functional group (R) comprises a maleimide (Mi) functional group.

15. The electric battery according to claim 13, wherein the functional group (R) comprises a thiophosphate (PSₓ), a thiogermanate (GeSₓ), a thioarsenate (AsSₓ) functional group, a selenophosphate (PSeₓ), a selenogermanate (GeSeₓ), or a selenoarsenate (AsSeₓ) functional group.

16. The electric battery according to claim 13, wherein the functionalized metal organic framework (R-MOF) comprises pores and the at least one of selenium (Se) or the sulfur (S) is deposited within said pores or the functionalized metal organic framework (R-MOF) and the at least one of selenium (Se) or the sulfur (S) are mixed together.

17. The electric battery according to claim 13, wherein the at least one of sulfur (S) or selenium (Se) is present in a proportion of 40 wt% to 90 wt% and the functionalized metal organic framework (MOF) is present in a proportion of 0.1 wt% to 30 wt%.

18. The electric battery according to claim 13, wherein the metal organic framework (MOF) comprises zirconium, hafnium, cesium, copper, zinc, titanium, iron, vanadium, molybdenum, niobium, or chromium metal ions.

19. The electric battery according to claim 18, wherein the metal organic framework (MOF) is selected from the group consisting of UiO-66, MOF-808 and NU-1000.

20. The electric battery according to claim 13, wherein the functional group (R) of the functionalized metal organic framework (R-MOF) is adapted to covalently react with the lithium polysulfide or sodium polysulfide to capture the lithium polysulfide or the sodium polysulfide.

21. The electric battery according to claim 13, wherein the lithium polysulfide comprises Li₂Sₓ.

22. The electric battery according to claim 13, wherein the sodium polysulfide comprises Na₂Sₓ.

23. A chemical composition for making an electrode for an electric battery comprising:
a metal organic framework (MOF) having an organic linker and a metal cluster; and
a functional group (R),
wherein the functional group is linked to the organic linker of the metal organic framework to form functionalized metal organic framework (R-MOF),
wherein the functionalized metal organic framework (R-MOF) is adapted to react with at least one of electrochemically accessible sulfur (S) or selenium (Se) to capture at least one of lithium polysulfide or sodium polysulfide via covalent attachment of sulfur (S) or selenium (Se), respectively, to the functional group of the functionalized metal organic framework (R-MOF).

24. The chemical composition according to claim 23, wherein the functional group (R) comprises a Maleimide (Mi) functional group.

25. The chemical composition according to claim 23, wherein the functional group (R) comprises a thiophosphate (PSₓ), a thiogermanate (GeSₓ), a thioarsenate (AsSₓ) functional group, a selenophosphate (PSeₓ), a selenogermanate (GeSeₓ), or a selenoarsenate (AsSeₓ) functional group.

26. The chemical composition according to claim 23, wherein the functionalized metal organic framework (R-MOF) comprises pores and the at least one of selenium (Se) or the sulfur (S) is deposited within said pores or the functionalized metal organic framework (R-MOF) and the at least one of selenium (Se) or the sulfur (S) are mixed together.

27. The chemical composition according to claim 23, wherein the at least one of sulfur (S) or selenium (Se) is present in a proportion of 40 wt% to 90 wt% and the functionalized metal organic framework (R-MOF) is present in a proportion of 0.1 wt% to 30 wt%.

28. The chemical composition according to claim 23, wherein the metal organic framework (MOF) comprises zirconium, hafnium, cesium, copper, zinc, titanium, iron, vanadium, molybdenum, niobium, or chromium metal ions.

29. The chemical composition according to claim 28, wherein the functionalized metal organic framework (R-MOF) is selected from the group consisting of UiO-66, MOF-808 and NU-1000.

30. The chemical composition according to claim 23, wherein the functional group (R) of the functionalized metal organic framework (R-MOF) is adapted to covalently react with the lithium polysulfide or sodium polysulfide to capture the lithium polysulfide or the sodium polysulfide.

31. The chemical composition according to claim 23, wherein the lithium polysulfide comprises Li₂Sₓ.

32. The chemical composition according to claim 23, wherein the sodium polysulfide comprises Na₂Sₓ.

33. A method of producing a chemical composition for making an electrode for an electric battery comprising:
providing a metal organic framework (MOF) having an organic linker and a metal cluster, the metal cluster comprising zirconium (Zr);
linking a functional group (R) to said metal organic framework (MOF) to form a functionalized metal organic framework (R-MOF) by incorporating a thiophosphate (PSₓ), a thiogermanate (GeSₓ), or a thioarsenate (AsSₓ) functional group to the organic linker via a hydroxyl (—OH) group, the hydroxyl (—OH) group being used so that PCl₅ reacts with the organic linker using the following chemical reaction: 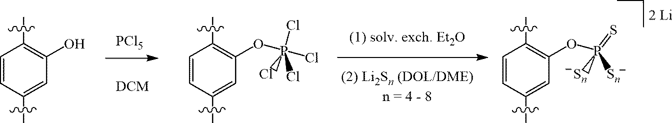
wherein P corresponds to phosphate and Cl corresponds to chlorine, and
wherein wiggly lines in the chemical reaction correspond to chemical bonds to connect to the metal cluster.

34. The method according to claim 33, wherein the functionalized metal organic framework (R-MOF) is adapted to react with at least one of electrochemically accessible sulfur (S) or selenium (Se) to capture at least one of lithium polysulfide or sodium polysulfide via covalent attachment of sulfur (S) or selenium (Se), respectively, to the functional group (R) of the functionalized metal organic framework (R-MOF).
